(19) United States
(12) Patent Application Publication
(10) Pub. No.: US 2024/0061546 A1
(43) Pub. Date: Feb. 22, 2024

(54) IMPLEMENTING CONTACTLESS INTERACTIONS WITH DISPLAYED DIGITAL CONTENT

(71) Applicant: Mobeus Industries, Inc., Sparta, NJ (US)

(72) Inventor: Dharmendra ETWARU, Sparta, NJ (US)

(21) Appl. No.: 18/091,170

(22) Filed: Dec. 29, 2022

Related U.S. Application Data
(63) Continuation-in-part of application No. 17/972,586, filed on Oct. 24, 2022.
(60) Provisional application No. 63/399,470, filed on Aug. 19, 2022.

(51) Int. Cl. G06F 3/04815; G06V 40/20; G06T 19/00; G06T 7/20; G06T 7/70; G06T 7/50; G06F 3/01; G06F 3/0484

(52) U.S. Cl. CPC G06F 3/04815; G06V 40/20; G06T 19/00; G06T 7/20; G06T 7/70; G06T 7/50; G06F 3/017; G06F 3/0484; G06T 2200/24; G06T 2207/10016; G06T 2207/30196

(57) ABSTRACT

Systems and methods for controlling a target device includes receiving a data stream of image data. The method also includes displaying the data stream of image data on a data stream layer of a graphical user interface (GUI), identifying a first object in the data stream of image data; determining a first set of characteristics of the first object, and generating a form in a three-dimensional virtual interactive space of the GUI in response to the first set of characteristics. The three-dimensional virtual interactive space is a first superimposed layer over the data stream layer of the display.

### CROSS-REFERENCE TO RELATED APPLICATIONS

This application is a continuation-in-part of U.S. application Ser. No. 17/972,586, filed on Oct. 24, 2022, and entitled “IMPLEMENTING CONTACTLESS INTERACTIONS WITH DISPLAYED DIGITAL CONTENT,” which claims priority to U.S. Provisional Application No. 63/399,470, filed on Aug. 19, 2022, the entire contents of which are incorporated herein by reference.

### STATEMENT REGARDING FEDERALLY SPONSORED RESEARCH

N/A

### SUMMARY

The technology described herein provides methods and systems for communicating and interacting with computers, computer networks, or other electronic devices. More particularly, the present disclosure provides systems and methods that yield new peripherals for such computers, computer networks, or other electronic devices.

One configuration provides a system for implementing contactless interactions. The system includes an electronic processor configured to receive a data stream of image data, display the data stream of image data on a data stream layer of a graphical user interface (GUI), identify a first object in the data stream of image data, determine a first set of characteristics of the first object, and generate a form in a three-dimensional virtual interactive space of the GUI in response to the first set of characteristics. The three-dimensional virtual interactive space is a first superimposed layer over the data stream layer of the display.

Another configuration provides a method for implementing contactless interactions with displayed digital content. The method includes receiving a data stream of image data, displaying the data stream of image data on a data stream layer of a graphical user interface (GUI), identifying a first object in the data stream of image data, determining a first set of characteristics of the first object, and generating a form in a three-dimensional virtual interactive space of the GUI in response to the first set of characteristics. The three-dimensional virtual interactive space is a first superimposed layer over the data stream layer of the display.

This Summary and the Abstract are provided to introduce a selection of concepts in a simplified form that are further described below in the Detailed Description. The Summary and the Abstract are not intended to identify key features or essential features of the claimed subject matter, nor are they intended to be used as an aid in determining the scope of the claimed subject matter.

### BRIEF DESCRIPTION OF THE DRAWINGS

The following drawings are provided to help illustrate various features of non-limiting examples of the disclosure and are not intended to limit the scope of the disclosure or exclude alternative implementations.

FIG. 1 schematically illustrates a system for interacting with computers, computer networks, or other electronic devices according to some configurations provided herein.

FIG. 2 schematically illustrates a user device included in the system of FIG. 1 according to some configurations.

FIG. 3A schematically illustrate a virtual interactive space; FIG. 3B schematically illustrates another virtual interactive space; FIG. 3C schematically illustrates a virtual interactive regions; FIG. 3D schematically illustrates another virtual interactive space including a non-interactive region; FIG. 3E schematically illustrates another virtual interactive space including interactive regions; FIG. 3F schematically illustrates another virtual interactive space including interactive regions; FIG. 3G schematically illustrates a three-dimensional virtual interactive space; and FIG. 3H schematically illustrates another three-dimensional virtual interactive space according to some configurations.

FIG. 4 is a perspective view of a virtual interactive space relative to a display device plane according to some configurations.

FIG. 5A is a perspective view of a graphical user interface (GUI) including a three-dimensional virtual interactive space; and FIG. 5B is a front view of the GUI taken along plane I-I′ of FIG. 5A according to some configurations.

FIG. 6A illustrates an interaction example in a three-dimensional virtual interactive space; FIG. 6B illustrates another interaction example in a three-dimensional virtual interactive space; FIG. 6C illustrates yet another interaction example in a three-dimensional virtual interactive space; FIG. 6D illustrates yet another interaction example in a three-dimensional virtual interactive space; FIG. 6E illustrates yet another interaction example in a three-dimensional virtual interactive space; FIG. 6F illustrates yet another interaction example in a three-dimensional virtual interactive space; FIG. 6G illustrates yet another interaction example in a three-dimensional virtual interactive space; FIG. 6H illustrates yet another interaction example in a three-dimensional virtual interactive space; FIG. 6I illustrates yet another interaction example in a three-dimensional virtual interactive space; FIG. 6J illustrates yet another interaction example in a three-dimensional virtual interactive space; FIG. 6K illustrates yet another interaction example in a three-dimensional virtual interactive space; and FIG. 6L illustrates yet another interaction example in a three-dimensional virtual interactive space according to some configurations.

FIG. 7 illustrates an overview of a method for identifying and responding to an interaction in video data using frame buffer intelligence according to some configurations.

FIG. 8 illustrates an overview of another method for implementing contactless interactions according to some configurations.

FIG. 9 illustrates an overview of another method for implementing contactless interactions in a three-dimensional virtual interactive space according to some configurations.

### DETAILED DESCRIPTION OF THE PRESENT DISCLOSURE

Before the disclosed technology is explained in detail, it is to be understood the disclosed technology is not limited in its application to the details of construction and the arrangement of components set forth in the following description or illustrated in the following drawings. Other configurations of the disclosed technology are possible and configurations described and/or illustrated here are capable of being practiced or of being carried out in various ways.

It should also be noted that a plurality of hardware and software-based devices, as well as a plurality of different structural components may be used to implement the disclosed technology. In addition, configurations of the disclosed technology may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one configuration, the electronic based aspects of the disclosed technology may be implemented in software (for example, stored on non-transitory computer-readable medium) executable by one or more processors. As such, it should be noted that a plurality of hardware and software-based devices, as well as a plurality of different structural components may be utilized to implement various configurations of the disclosed technology. It should also be understood that although certain drawings illustrate hardware and software located within particular devices, these depictions are for illustrative purposes only. In some configurations, the illustrated components may be combined or divided into separate software, firmware, hardware, or combinations thereof. As one non-limiting example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

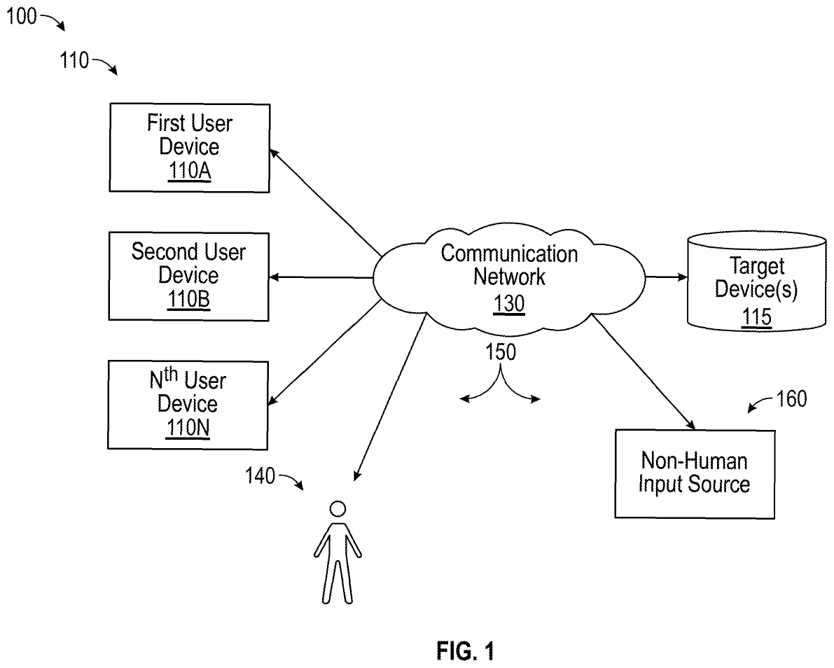

Referring now to the figures, FIG. 1 illustrates one, non-limiting example of a system 100 for communicating with computers, computer networks, or other electronic devices in accordance with the present disclosure. As will be described, the system 100 may be used to implement photon-based peripheral(s) to interact and communicate with computers, computer networks, or other electronic devices, for example, to provide a contactless peripheral for computers, computer networks, or other electronic devices.

In the illustrated example of FIG. 1, the system 100 includes one or more user devices 110 (referred to collectively herein as “the user devices 110” and individually as “the user device 110”) and a target device 115. The term “computer” used herein may refer to any of a variety of devices, including but not limited to individual computers, networked computers, servers, mobile computing devices, phones, tablets, or combinations of these devices and/or others. That is, the user device 110 may include a computing device, such as a desktop computer, a laptop computer, a tablet computer, a terminal, a smart telephone, a smart television, a smart wearable, or another suitable computing device that interfaces with a user (e.g., a human user or non-human user). As described in greater detail herein, the user device 110 may be used for interacting with digital content (also referred to herein as displayed digital content). As one non-limiting example, the user device 110 may detect (or otherwise receive) contactless interactions of between an input source and the user device 110 (e.g., displayed digital content provided via the user device 110).

In some configurations, the system 100 may include fewer, additional, or different components in different configurations than illustrated in FIG. 1. Thus, in the illustrated example, the system 100 includes three user devices 110 (e.g., a first user device 110A, a second user device 110B, and an n^{th} user device 110N). However, in some configurations, the system 100 may include fewer or additional user devices 110. As another non-limiting example, the system 100 may include multiple computers 115. As yet another non-limiting example, one or more components of the system 100 may be combined into a single device, divided among multiple devices, or a combination thereof.

The user devices 110 and the target device 115 may communicate over one or more wired or wireless communication networks 130. Portions of the communication networks 130 may be implemented using a wide area network, such as the Internet, a local area network, such as a Bluetooth™ network or Wi-Fi, and combinations or derivatives thereof. Alternatively, or in addition, in some configurations, two or more components of the system 100 may communicate directly as compared to through the communication network 130. Alternatively, or in addition, in some configurations, two or more components of the system 100 may communicate through one or more intermediary devices not illustrated in FIG. 1.

Furthermore, portions of the communications network 130 may include optical or photonic communications networks, such as will be described. That is, as will be described, a human user 140 may use the user device 110 to communicate with or interact with the target device 115, but the human user 140 may communicate directly with the target device 115 through the communication network 130, such as using a photon-based communications peripheral 150, which may allow the implementation of contactless communications with the target device 115.

To this end, the human user 140 (e.g., a human user) may operate as an input source to photon-based communications peripheral 150. Additional or alternatively, the photon-based communications peripheral 150 may also be designed for use with a non-human input source 160. Some non-limited examples of non-human input sources include an animal, a robot, an inanimate object, a predetermined software program, a dynamic software program, another type of automated program or system, or the like. In some configurations, the human user 140 or non-human input source 160 may be combined with one or more user devices 110 to, together, serve as an input source. As one non-limiting example, the input source may be in an environment external to the human user 140 and/or the user device 110, as will be described.

As mentioned above, the photon-based communications peripheral 150 may implement a contactless communication process where contactless interactions are used to communicate and/or interact with the target device 115. A contactless interaction may refer to an interaction that is conducted with limited or no direct physical contact with a physical device, but instead utilizes a photon-based communications peripheral 150, as will be described. A contactless interaction may include interactions between one or more entities or objects, one or more devices, or a combination thereof. As one non-limiting example, a contactless interaction may include an interaction between a user (e.g., a human) and the target device 115. As another non-limiting example, a contactless interaction may include an interaction between a non-human user (e.g., a robot, an automated system, etc.) and the target device 115. As yet another non-limiting example, a contactless interaction may include an interaction between an inanimate object (e.g., a door) and the target device 115. In some configurations, a contactless interaction may occur without a wired connection, a wireless connection, or a combination thereof between an input source and a device (e.g., the user device 110). A contactless interaction may include, e.g., gesture-based, audible-based (e.g., voice command), etc. As one non-limiting example, a user may interact with the user device 110 by performing a gesture (as a contactless interaction), where the gesture is detected (or perceived) by the target device 115 and/or may be detected by the user device 110 and communicated to the target device 115.

A gesture may refer to a movement of an input source (human user 140 or non-human 160) that expresses an idea or meaning. A movement of an input source may include a human user 140 moving an inanimate object. As one non-limiting example, when the inanimate object is a coffee cup, a gesture may be a human user tilting the coffee cup and taking a drink. In some configurations, a movement of an input source may include a movement of the human user 140 (or a portion thereof). As one non-limiting example, a human user 140 moving from a standing position to a sitting position may be a gesture. As another non-limiting example, a user's open hand moving from back and forth along a common axis or plane may be a feature (e.g., a waving gesture). In some configurations, a movement of a non-human input source 160 may also be a gesture. As one non-limiting example, a cat (as a non-human input source 160) jumping onto a couch may be a gesture. As another non-limiting example, a dog (as a non-human input source 160) sniffing and scratching at a door may be a gesture. As yet a further non-limiting example, a door (as a non-human input source 160) opening may be a gesture.

Digital content generally refers to electronic data or information provided to or otherwise accessible by a user such that a user may interact with that electronic data or information. Digital content may be referred to herein as electronic content or displayed digital content. The digital content may include, for example, a word processor document, a diagram or vector graphic, a text file, an electronic communication (for example, an email, an instant message, a post, a video message, or the like), a spreadsheet, an electronic notebook, an electronic drawing, an electronic map, a slideshow presentation, a task list, a webinar, a video, a graphical item, a code file, a website, a telecommunication, streaming media data (e.g., a movie, a television show, a music video, etc.), an image, a photograph, and the like. The digital content may include multiple forms of content, such as text, one or more images, one or more videos, one or more graphics, one or more diagrams, one or more charts, and the like. As described in greater detail herein, in some configurations, digital content may be accessible (or otherwise provided) through a web-browser (e.g., Google® Chrome, Microsoft® Edge, Safari, Internet Explorer, etc.). Alternatively, or in addition, digital content may be accessible through another software application, such as a communication application, a productivity application, etc., as described in greater detail herein.

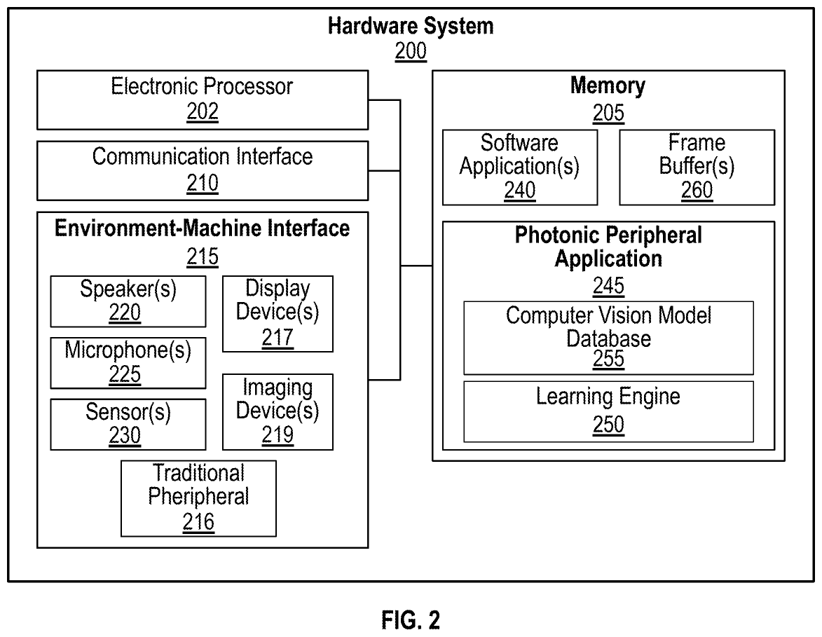

FIG. 2 schematically illustrates an example hardware system 200 for implementing the photon-based communications peripheral 150 of FIG. 1. The hardware system 200 may be embodied by one device, such as the user device 110 or target device 115 of FIG. 1. Alternatively, the hardware system 200 may be embodied via a combination of the user device 110 and the target device 115, and/or other systems. As illustrated in FIG. 2, hardware system 200 includes an electronic processor 202, a memory 205, a traditional communication interface(s) 210, and an environment-machine interface (“EMI”) 215. The electronic processor 202, the memory 205, the communication interface 210, and the EMI 215 may communicate wirelessly, over one or more communication lines or buses, or a combination thereof. The hardware system 200 may include additional, different, or fewer components than those illustrated in FIG. 2 in various configurations. The hardware system 200 may perform additional functionality other than the functionality described herein. Also, the functionality (or a portion thereof) described herein as being performed by the hardware system 200 may be performed by another component (e.g., the user device 110, the target device 115, another computing device, or a combination thereof), distributed among multiple components (e.g., as part of a cloud service or cloud-computing environment), combined with another component (e.g., the target device 115, user device 110, another computing device, or a combination thereof), or a combination thereof.

The communication interface 210 may include a transceiver that communicates with other user device(s) 110, other target device(s) 115, or others interacting with the system 100 over the communication network 130 of FIG. 1. The electronic processor 202 may include a microprocessor, an application-specific integrated circuit (“ASIC”), or another suitable electronic device for processing data, and the memory 205 may include a non-transitory, computer-readable storage medium. The electronic processor 202 may be configured to retrieve instructions and data from the memory 205 and execute the instructions. In some configurations, the electronic processor 202 may include or be a graphics processing unit (“GPU”), a central processing unit (“CPU”), a combination of GPU and CPU, or the like. A GPU generally refers to an electronic circuit designed to manipulate and alter memory to accelerate the creation of images in a frame buffer intended for output through a display device.

As illustrated in FIG. 2, the user device 110 may also include the EMI 215 for interacting with an environment (or surrounding) external to the target device 115 and/or user device 110, such as, e.g., an input source 140, 160 of FIG. 1. In some configurations, the EMI 215 may function similar to a human-machine interface (“HMI”) with additional functionality related to receiving input from non-human input sources.

The EMI 215 may include one or more input devices, one or more output devices, or a combination thereof. Accordingly, in some configurations, the EMI 215 allows a human user 140 of FIG. 1 (or non-human user 160 of FIG. 1) to interact with (e.g., provide input to and receive output from) the target device 115 of FIG. 1. For example, the EMI 215 may include traditional peripheral devices 216, such as a keyboard, a cursor-control device (e.g., a mouse), a touch screen, a scroll ball, a mechanical button, a printer, or the like or a combination thereof. Also, in the non-limited illustrated example of FIG. 2, the EMI 215 includes at least one display device 217 (referred to herein collectively as “the display devices 217” and individually as “the display device 217”). As one non-limiting example, the display device 217 may be a touchscreen included in a laptop computer, a tablet computer, or a smart telephone. As another non-limiting example, the display device 217 may be a monitor, a television, or a projector coupled to a terminal, desktop computer, or the like. As described in greater detail herein, the display device 217 may provide (or output) digital content to a user.

The EMI 215 may also include at least one imaging device 219 (referred to herein collectively as “the imaging devices 219” and individually as “the imaging device 219”). The imaging device 219 may be a physical or hardware component associated with the user device 110 or target device 115 of FIG. 1 (e.g., included in the user device 110 or target device 115 or otherwise communicatively coupled with the user device 110 or target device 115). The imaging device 219 may electronically capture or detect a visual image (as an image data signal or data stream). A visual image may include, e.g., a still image, a moving-image, a video stream, an image stream, other data associated with providing a visual output, and the like. The imaging device 219 may be a camera, such as, e.g., a webcam, a digital camera, etc., or another type of image sensor.

The EMI 215 may also include at least one audio device, such as one or more speakers 220 (referred to herein collectively as “the speakers 220” and individually as “the speaker 220”), one or more microphones 225 (referred to herein collectively as “the microphones 225” and individually as “the microphone 225”), or a combination thereof. The speaker 220, the microphone 225, or a combination thereof may be a physical or hardware component associated with the user device 110 and/or target device 115 of FIG. 1 (e.g., included in the user device 110 or target device 115 or otherwise communicatively coupled therewith). The speaker 220 may receive an electrical audio signal, convert the electrical audio signal into a corresponding sound (or audible audio signal), and output the corresponding sound (as an audio data stream). The microphone 225 may receive an audible audio signal (e.g., a sound) and convert the audible audio signal into a corresponding electrical audio signal (as an audio data stream). Although not illustrated in FIG. 2, the user device 110 may include additional or different components associated with receiving and outputting audio signals, such as, e.g., associated circuitry, component(s), power source(s), and the like, as would be appreciated by one of ordinary skill in the art. In some configurations, the microphone 225 and the speaker 220 may be combined into a single audio device that may receive and output an audio signal (or audio data or data stream).

In the illustrated example of FIG. 2, in some configurations, the EMI 215 may include one or more sensors 230 (referred to herein collectively as “the sensors 230” and individually as “the sensor 230”). The sensor(s) 230 may receive or collect data associated with an external environment of the user device 110 (as environment data). A sensor 230 may include, e.g., an image sensor, a motion sensor (e.g., a passive infrared (“PIR”) sensor, an ultrasonic sensor, a microwave sensor, a tomographic sensor, etc.), a temperature sensor, a radio-frequency identification (“RFID”) sensor, a proximity sensor, or the like. An image sensor may include, e.g., a thermal image sensor, a radar sensor, a light detection and ranging (“LIDAR”) sensor, a sonar sensor, a near infrared (“NIR”) sensor, etc. The image sensor may convert an optical image into an electronic signal. As one non-limiting example, the sensor 230 may be a lidar sensor used for determining ranges of an object or surface (e.g., an input source).

In some configurations, the functionality (or a portion thereof) described herein as being performed by the sensor(s) 230 may be performed by another component (e.g., the display device(s) 217, the imaging device(s) 219, the speaker(s) 220, the microphone(s) 225, another component of the user device 110 or target device 115 of FIG. 1, or a combination thereof), distributed among multiple components, combined with another component, or a combination thereof. As one non-limiting example, when the sensor 230 includes an image sensor, the imaging device 219 may perform the functionality (or a portion thereof) of the sensor 230. In some configurations, the imaging device 219 may be an image sensor.

As illustrated in FIG. 2, the memory 205 may include one or more software applications 240 (referred to herein collectively as “the software applications 240” and individually as “the software application 240”). The software application(s) 240 is a software application executable by the electronic processor 202 in the example illustrated and as specifically discussed below, although a similarly purposed module can be implemented in other ways in other examples. In some configurations, the software application(s) 240 may be a dedicated software application locally stored in the memory 205 of the user device 110. Alternatively, or in addition, the software application(s) 240 may be remotely hosted and accessible from a server (e.g., separate from the target device 115 or user device(s) of FIG. 1), such as where the software application(s) 240 is (or enables) a web-based service or functionality.

The software application(s) 240 may include, e.g., a word-processing application (e.g., Microsoft® Word, Google Doc™, Pages® by Apple Inc., etc.), a spreadsheet application (e.g., Microsoft® Excel®, Google Sheets, Numbers® by Apple Inc., etc.), a presentation application (e.g., Microsoft® PowerPoint®, Google Slides™, Keynote® by Apple Inc., etc.), a task management application (e.g., Microsoft® To Do, Google Tasks, etc.), a note-taking application (e.g., Microsoft® OneNote®, Apple Notes, etc.), a drawing and illustration application (e.g., Adobe® Photoshop®, Adobe® Illustrator®, Adobe® InDesign®, etc.), an audio editing application (e.g., GarageBand® by Apple Inc., Adobe® Audition®, etc.), a video editing application (e.g., Adobe® Premiere®, Apple® Final Cut®, Apple® iMovie, etc.), a design or modeling application (e.g., Revit®, AutoCAD®, CAD, SolidWorks®, etc.), a coding or programing application (e.g., Eclipse®, NetBeans®, Visual Studio®, Notepad++, etc.), a communication application (e.g., Google Met, Microsoft Teams, Slack, Zoom, Snapchat, Gmail, Messenger, Microsoft Messages, Skype, etc.), a database application (e.g., Microsoft® Access®, etc.), a web-browser application (e.g., Google Chrome™, Microsoft® Edge®, Apple® Safari®, Internet Explorer®, etc.), and the like.

As illustrated in FIG. 2, the memory 205 may include a photonic peripheral application 245. The photonic peripheral application 245 is a software application executable by the electronic processor 202 in the example illustrated and as specifically discussed below, although a similarly purposed module can be implemented in other ways in other examples. The photonic peripheral application 245 may be an application or a service, setting, or control panel setting of an operating system that enables access and interaction with a contactless interaction platform or service, such as, e.g., a contactless interaction platform associated with the target device 115 of FIG. 1. Alternatively, or in addition, the photonic peripheral application 245 may be a dedicated software application that enables access and interaction with a contactless interaction platform, such as, e.g., a contactless interaction platform associated with (or hosted by) the target device 115 of FIG. 1. Accordingly, in some configurations, the photonic peripheral application 245 may function as a software application that enables access to a contactless interaction platform or service provided by the target device 115 of FIG. 1. As will be described such contactless interactions using the platform or service may be referred to as “interactive air.” That is, as described in more detail herein, the electronic processor 202 executes the photonic peripheral application 245 to enable contactless interaction with displayed digital content such that the user experiences “interactive air”. As one non-limiting example, the photonic peripheral application 245 (when executed by the electronic processor 202) may detect a contactless interaction with displayed digital content and execute (or otherwise perform) interactive functionality associated with the contactless interaction (as described in greater detail herein).

In some configurations, the electronic processor 202 uses one or more computer vision techniques as part of implementing contactless interactions and providing “interactive air” (via the photonic peripheral application 245). Computer vision (“CV”) generally refers to a field of artificial intelligence in which CV models are trained to interpret and understand the visual world (e.g., an external environment). A CV model may receive digital content, such as a digital image, from a device (e.g., the imaging device(s) 219, the sensor(s) 230, or the like) as an input. The CV model may then process or analyze the digital content in order to interpret and understand an environment external to the camera. A CV model may be implemented for image recognition, semantic segmentation, edge detection, pattern detection, object detection, image classification, feature recognition, object tracking, facial recognition, and the like. As described in greater detail herein, in some configurations, the electronic processor 202 may use CV techniques (or CV model(s)) to detect contactless interaction between an input source and the user device 110. As one non-limiting example, the electronic processor 202 may use a CV model to identify a human user or input source 140 or non-human input source 160 of FIG. 1 in an image data stream, track or monitor that input source 140, 160 to detect a set of characteristics, actions, events, and the like as an input signal and empower the hardware system 200 to take actions based thereon.

As one non-limiting example, as illustrated in FIG. 2, the memory 205 may store a learning engine 250 and a computer vision (“CV”) model database 255. In some configurations, the learning engine 250 develops one or more CV models using one or more machine learning functions. Machine learning functions are generally functions that allow a computer application to learn without being explicitly programmed. In particular, the learning engine 250 is configured to develop an algorithm or model based on training data. As one non-limiting example, to perform supervised learning, the training data includes example inputs and corresponding desired (for example, actual) outputs, and the learning engine 250 progressively develops a model (for example, a CV model) that maps inputs to the outputs included in the training data. Machine learning performed by the learning engine 250 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 250 to ingest, parse, and understand data and progressively refine models.

Examples of artificial intelligence computing systems and techniques used for CV may include, but are not limited to, artificial neural networks (“ANNs”), generative adversarial networks (“GANs”), convolutional neural networks (“CNNs”), recurrent neural networks (“RNNs”), thresholding, support vector machines (“SVMs”), and the like. As one non-limiting example, in some configurations, the learning engine 250 may develop a CV model using deep learning and a neural network, such as a CNN, a RNN, or the like for implementation with contactless interactions with displayed digital data.

CV models generated by the learning engine 250 can be stored in the CV model database 255. As illustrated in FIG. 2, the CV model database 255 is included in the memory 205 of the user device 110. It should be understood, however, that, in some embodiments, the CV model database 255 is included in a separate device accessible by the target device 115 or user device 110 of FIG. 1 (including a remote database, and the like).

As also illustrated in FIG. 2, the memory 205 may store one or more frame buffers 260 (referred to herein collectively as “the frame buffers 260” and individually as “the frame buffer 260”). A frame buffer generally represents a portion of memory, such as random-access memory (“RAM”), that contains a bitmap that drives a video or image display. In some instances, a frame buffer may be referred to as a memory buffer containing data representing pixels in a complete video or image frame. As noted above, in some configurations, the electronic processor 202 may include or be a GPU. A GPU generally refers to an electronic circuit designed to manipulate and alter memory to accelerate the creation of images in a frame buffer (e.g., the frame buffer(s) 260) intended for output for a display device (e.g., the display device(s) 217). In some configurations, the user device 110 may call graphics that are displayed on the display device(s) 217 (e.g., as displayed digital content). The graphics of the user device 110 may be processed by the GPU (e.g., the electronic processor 202) and rendered in frames stored on the frame buffer 260 that may be coupled to the display device(s) 217. The frame buffer 240 may be associated with, coupled to, or incorporated in a GPU of a display, an image capturing device, and/or a sensor device, such as, without limitation, a digital camera, a light detection and ranging (“LiDAR”) or a radar device, or other types of sensing devices (e.g., the display device(s) 217, the imaging device(s) 219, the sensor(s) 230, or another component of the user device 110).

The memory 205 may include additional, different, or fewer components in different configurations. Alternatively, or in addition, in some configurations, one or more components of the memory 205 may be combined into a single component, distributed among multiple components, or the like. Alternatively, or in addition, in some configurations, one or more components of the memory 205 may be stored remotely from the target device 115, a user device 110, or, in a remote database, a remote server, another user device, an external storage device, or the like.

As described in greater detail herein, configurations disclosed herein may implement contactless interactions with displayed digital content (e.g., digital content displayed via the display device 217). That is, the hardware system 200 (via the electronic processor 202) may facilitate the interactivity between an input source (human and/or non-human) as will be described.

In some configurations, the hardware system 200 (via the electronic processor 202) implements one or more CV techniques (e.g., one or more CV models) to analyze a data stream of image data, such as image data collected by one or more components of the EMI 215 (e.g., the imaging device(s) 219, the sensor(s) 230, or the like). Alternatively, or in addition, in some configurations, the hardware system 200 (e.g., the electronic processor 202) may analyze or interpret one or more of the frame buffers 260 as part of analyzing a data stream of image data. The hardware system 200 (e.g., the electronic processor 202) may analyze the image data to, e.g., identify or recognize one or more object(s) (or portions thereof) in an environment external to the target device 115 of FIG. 1. The hardware system 200 (e.g., the electronic processor 202) may further track the object(s), determine one or more characteristics of the object(s), associate the objects(s) or characteristics thereof with an interactive function, etc. The hardware system 200 (e.g., the electronic processor 202) may then detect or determine one or more interactions of the object(s) with digital content displayed via the display device 217. The hardware system 200 (e.g., the electronic processor 202) may perform (or otherwise execute) the one or more interactive functions associated with the interaction, such that a functionality associated with the interaction of the object with the target device 115 is performed.

Accordingly, in some configurations, the methods and systems described herein enable contactless interaction between an input source (or object) and a device (e.g., the target device 115). In some configurations, the interactivity between the object and the target device 115 may be based on a position of the object (or a portion thereof). Alternatively, or in addition, in some configurations, the interactivity between the object and the target device 115 may be based on a movement or gesture performed by the object (or a portion thereof).

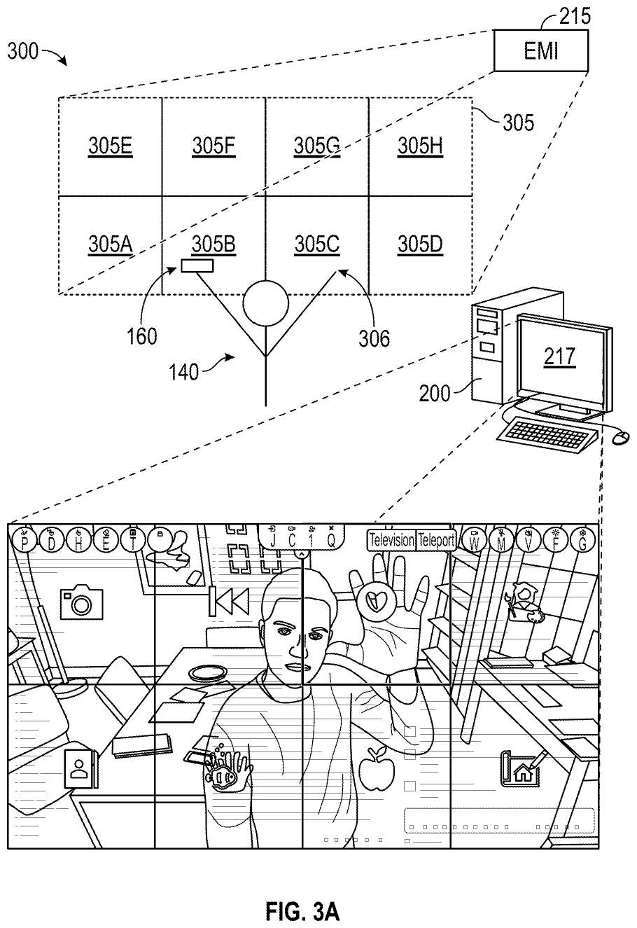

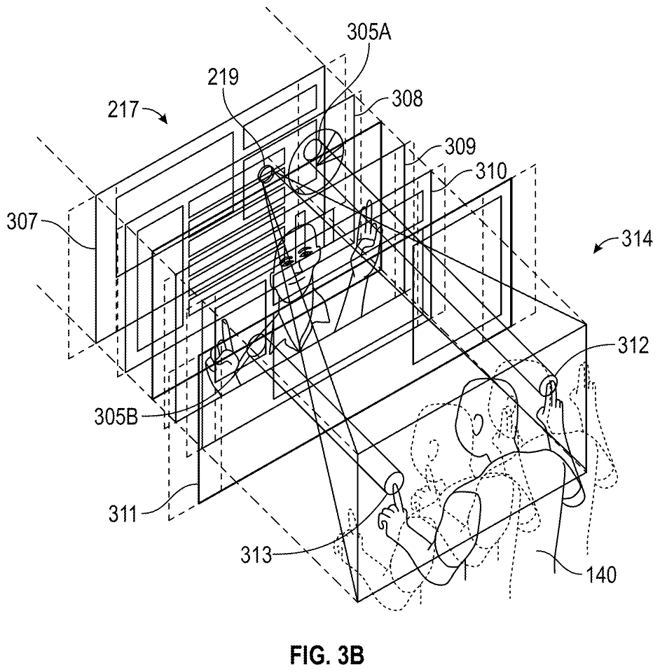

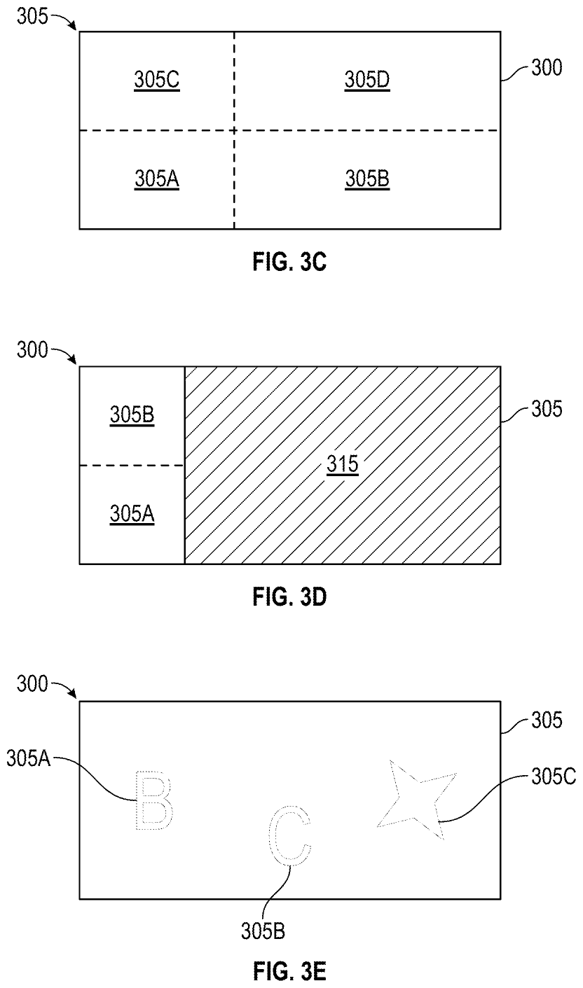

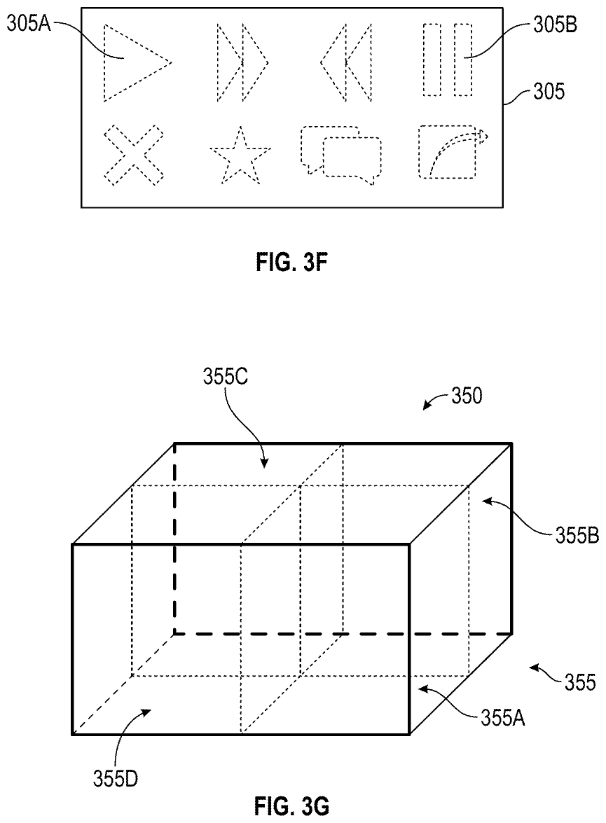

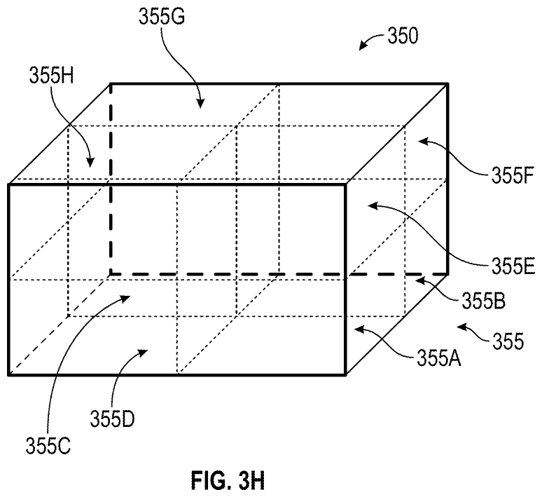

Referring to FIGS. 2 and 3A, the hardware system 200 (via the electronic processor 202 along with the EMI 215) may create an interactive space 300 that is located in the surrounding environment. The interactive space 300 may be located in a void space, i.e., in the “air” (and, thus, be referred to as “interactive air”). Additionally, or alternatively, the interactive space 300 may be located on or proximate to or include physical objects in the surrounding environment (e.g., such as walls, doors, or other structures; furniture or furnishing; electronic systems or devices; or the other structures, devices, objects, or the lack thereof).

In the non-limiting example of FIG. 3A, the interactive space 300 may be two-dimensions (“2D”) defined for interactivity between an input source (e.g., human user 140 or a non-human object 160 or portion thereof) and the target device 115 of FIG. 1 via EMI 215. For example, FIG. 3A illustrates only one example interactive space 300 according to some configurations. An interactive space may generally refer to a physical space external to a device (e.g., the target device 115) in which an interaction may occur. In the illustrated example, the interactive space 300 represents a two-dimensional space (or plane). In the non-limiting example of FIG. 3A, the interactive space 300 may be mapped to any of a variety of locations, interactions, functions, or the like. In one non-limiting example, the interactive space 300 may correspond to a display region of the display device 217. As one non-limiting example, the interactive space 300 may be mapped to an area of the display device 217 of FIG. 2 (e.g., an area of the display device 217 in which digital content may be displayed, as displayed digital content). Alternatively, the interactive space 300 may be mapped to particular controls, or functions irrespective of what is displayed or communicated by the display device 217 or any other interface device. For example, the interactive space 300 may define actions or may have any of a variety of functions or purposes, such as will be described.

For example, in some configurations, the interactive space 300 may be configured for location-based interactions and, thus, may include one or more virtual interactive regions 305. The virtual interactive region 305 may be a region in which a contactless interaction is detectable (e.g., a location in which contactless interaction detection is enabled or monitored). In contrast, a non-interactive region may be a region in which a contactless interaction is not detectable (e.g., a region in which contactless interaction detection is disabled or not monitored and/or areas outside of the virtual interactive region 305 or the broader interactive space 300).

As one non-limiting example, as illustrated in FIG. 3A, the interactive space 300 may include the virtual interactive regions 305 that are divided or presented in a particular way: a first virtual interactive region 305A, a second virtual interactive region 305B, a third virtual interactive region 305C, a fourth virtual interactive region 305D, a fifth virtual interactive region 305E, a sixth virtual interactive region 305F, a seventh virtual interactive region 305G, and an eighth virtual interactive region 305H. Although the example illustrated in FIG. 3A shows the virtual interactive space 300 as including the 2D virtual interactive regions 305 as having eight virtual interactive regions 305A-305H, the virtual interactive space 300 may include additional, different, or fewer virtual interactive regions 305 and may include additional virtual interactive regions, such as regions forming a three-dimensional (“3D”) space, as will be described. As one non-limiting example, FIG. 3C illustrates the virtual interactive region 300 having four virtual interactive regions 305 (e.g., the first virtual interactive region 305A, the second virtual interactive region 305B, the third virtual interactive region 305C, and the fourth virtual interactive region 305D).

In one non-limiting example, when a human user 140 is acting as an input source, the human user 140 can extend a hand 306 into the virtual interactive regions 305. In a location-based control paradigm, the EMI 215 detects the human user 140 hand 306 in the virtual interactive regions 305 and can understand this as a communicated command. That is, in the non-limited example illustrated in FIG. 3A, the human user 140 hand 306 is located in one virtual interactive region 305B. This virtual interactive region 305B can be mapped or interpreted as communicating a command and, thus, causing the hardware system 200 of FIG. 2, which may be the target device 115 of FIG. 1, to carry out the command.

In one non-limiting example, the EMI 215 may have mapped the virtual interactive regions 305 to particular commands associated with an application being run by the hardware system 200 and cause an action to be performed within the context of the application that corresponds to the command. In one non-limiting example, the application may be a presentation application and the particular virtual interactive region 305B where the human user 140 hand 306 is located may be mapped to advancing the slide in the presentation. Thus, when the human user 140 places a hand 306 in the particular virtual interactive region 305B, a presentation being displayed is advanced on display 217.

Additionally or alternatively, the virtual interactive regions 305 can be shown on the display 217, along with video of the human user 140 and/or the application running on the hardware system 200, thereby providing a transparent computing implementation that is coordinated with the virtual interactive regions 305. In one non-limiting example and referring to FIG. 3B, one or more image capturing or sensor devices 219 can be used to capture image or video data of the human user 140 (or non-human 160, as will be described) interacting with the virtual interactive regions. In the non-limited example of FIG. 3B, the sensor device(s) 219 can be integrated into or connected to the display 217.

As illustrated, the display 217 can display a variety of layers that form, for example, a volumetric composite. A first layer may be an application layer 307 that shows the content or windows or the like associated with an application that is currently running, such as the above-described presentation software. A second layer may include a virtual interactive region 305A for communicating commands relative to the application, such as advancing the presentation, as described above, to form an application command layer or content-activated layer 308. A third layer may be sensor capture layer 309, which in this non-limiting example, is displaying video of the human user 140. A fourth layer may be a control layer 310, such as to illustrate the virtual interactive regions 305, so that the human user 140 can readily see when the sensor capture layer 309 shows a hand reaching a virtual interactive region 305, such as 305A or, as will be described 305B. A fifth layer may include a further virtual interactive region 305B, which may communicate commands, for example, that extend beyond the application, or to another layer, thereby forming a content-agnostic layer 311.

The above-described ability to create a volumetric composite of content-activated layers of transparent computing, utilizes a photon-driven communications network. That is, the sensor device 219, as described above, optically monitors for and tracks any of a variety of components of the network, which may include a user or a portion of a user (e.g., hand, eyes, etc.), a device, another camera, and/or other component. Actions taken by the identified and monitored components of the network are optically observed by the sensor device 219 (e.g., using any of a variety of spectrum, including visible and non-visible light), thereby communicating to information that is received by the sensor device 219. In this way, a photon-driven network is established. Observation and tracking by the sensor device 219 creates a unidirectional communications path of the network. Then, if included, the 2-dimensional or 3-dimensional content display or displays 217 provides a second unidirectional communication path back to the user, device, camera, or the like that interacts with the sensor device 219. Thus, a bi-directional photon-driven communications network 314 is established that provides a photonic peripheral through which a human user 140 or non-human user (not shown in FIG. 3B) is able to communicate commands and control a target device or application running on the target device.

In one non-limiting example of operating the photon-driven communications network 314, when the human user 140 moves a first-hand 312 to a position that is understood relative to the virtual interactive region 305A of the content-activated layer 308, the application layer 307 reflects the implementation of the command (e.g., advancing the slide of a presentation or emphasizing the content displayed in the interactive region 305A upon a “collision” of the first hand 312 and an edge of content in the content-activated layer 308). Then, when the human user 140 moves a second hand 313 to a position that is understood relative to the virtual interactive region 305B of the content-agnostic layer 311, a different action is performed, such as one not germane to the application layer 307, such as changing the transparency of the sensor capture layer 309 or audio.

Although non-limiting examples included herein describe implementations using one or more hands of the human user 140, it should be understood that other body parts of the human user 140 may be used. For instance, in some configurations, the object may include another body part of the human (e.g., a leg, a finger, a foot, a head, etc.), the human user 140 as a whole (e.g., where the object is the entirety of the human user 140), etc. Alternatively, or in addition, in some configurations, such as configurations involving multiple objects, the object may include various combinations of body parts, such as, e.g., a head and a hand, a finger and a foot, etc. Further, in instances involving multiple objects, the object may include various combinations of body parts, inanimate objects, non-human users, etc. As one non-limiting example, a first object may include a hand of the human user 140 and a second object may include a door (as an inanimate object). Alternatively, or in addition, it should be understood that additional, fewer, or different commands may be implemented, such as, e.g., highlighting, changing color, bolding, enlarging, animating, etc.

The above-described example provided with respect to FIG. 3B relates to position or location-based communication and control. Many other paradigms are also provided. For example, in addition to using location or position as a command, gestures may be used. As illustrated, the human user may communicate a first command by raising two fingers with the first hand 312 and send a different command by raising one finger with the second hand 313. These gestures or any of a variety of other gestures may be performed alone or in combination with location or position-based commands.

A variety of other configurations and operations are also provided. In some configurations, the virtual interactive regions 305 of the virtual interactive space 300 may have a similar (or the same) area. As one non-limiting example, FIG. 3A illustrates the virtual interactive space 300 with eight uniformly sized virtual interactive regions 305. Alternatively, or in addition, two or more of the virtual interactive regions 305 may have a different size. As one non-limiting example, with respect to the virtual interactive space 300 of FIG. 3C, the first virtual interactive region 305A has a different size than the second virtual interactive region 305B and the third virtual interactive region 305C has a different size than the fourth virtual interactive region 305D.

In some configurations, the virtual interactive regions 305 may include (or cover) the entire area of the virtual interactive space 300, such that each portion of the virtual interactive space 300 is associated with a virtual interactive region 305, as illustrated in FIGS. 3A-3C. Alternatively, or in addition, in some configurations, at least a portion of the virtual interactive space 300 may be associated with a non-interactive region. As one non-limiting example, FIG. 3D illustrates the virtual interactive space 300 including a non-interactive region 315.

In some configurations, the virtual interactive regions 305 of the virtual interactive space 300 may be rectangular or square shaped, as illustrated in FIGS. 3A-3D. However, in some configurations, one or more of the virtual interactive regions 305 may be another shape, such as a diamond, a circle, an octagon, etc. Alternatively, or in addition, in some configurations, one or more of the virtual interactive regions 305 may be an irregular shape, a custom shape, or the like. For instance, a virtual interactive region 305 may be a character, a letter, a symbol, a number, an icon, a hand-drawn shape, etc. As one non-limiting example, FIG. 3E illustrates the virtual interactive space 300 having three virtual interactive regions 305: a first virtual interactive region 305A shaped as a “B”, a second virtual interactive region 305B shaped as a “C”, and a third virtual interactive region 305C shaped as a star.

In some configurations, a boundary or edge of the virtual interactive region 305 may visually resemble or represent an interactive function associated with the virtual interactive region 305, as described in greater detail herein. As one non-limiting example, FIG. 3F illustrates the virtual interactive space 300 including a first virtual interactive region 305A that visually represents or depicts a “play” symbol and a second virtual interactive region 305B that visually represents or depicts a “pause” symbol. Of course, as virtual spaces, a human user cannot “see” this shape, but can know that the upper, left region 305A communicates “play” while the upper right region communicates “pause.” That is, following this example, the first virtual interactive region 305A may be associated with a play command or function (as an interactive function) and the second virtual interactive region 305B may be associated with a pause command or function (as an interactive function). In this way, a user no longer has a need for a traditional remote control for watching or controlling content, as all fundamental commands (e.g., play, pause, fast-forward, skip, rewind, back skip, volume up, volume down, and the like) can be mapped to locations and/or gestures.

As a further illustrative example, the virtual interactive region 305 of FIG. 3F can be utilized with respect to a frame of video data from a video capture device. In this case, the frame or video can be divided into eight rectangular regions, with each of the rectangular regions displaying the same or different image data. The virtual interactive region 305 can be overlayed on a video player. In one embodiment, the frame of video data can include at least one transparent region. Each of the eight regions can correspond to a media control function of video player. As described, playing a video in the video player, the left region 305A can correspond to playing the video and the right region 305B cam correspond to pausing the video in the video player. Other regions can correspond to fast-forwarding the video in the video player, rewinding the video in the video player, closing the video in the video player, giving a rating of the video in the video player, displaying captions on the video in the video player, opening another page in the video player, or any of a variety of other actions. A gesture can be identified in the video data, wherein the location of the gesture within the frame of video data can be within one of the eight regions. The action corresponding to the region of the gesture can be executed in response to the gesture.

In some configurations, the virtual interactive space may be formed as a three-dimensional (“3D”) space. As one non-limiting example, FIGS. 3G and 3H illustrate an example 3D virtual interactive space 350. As illustrated in the example of FIG. 3G, the 3D virtual interactive space 350 includes four 3D interactive regions 355: a first 3D interactive region 355A, a second 3D interactive region 355B, a third 3D interactive region 355C, and a fourth 3D interactive region 355D. As illustrated in the example of FIG. 3H, the 3D virtual interactive space 350 includes eight 3D interactive regions 355: the first 3D interactive region 355A, the second 3D interactive region 355B, the third 3D interactive region 355C, the fourth 3D interactive region 355D, a fifth 3D interactive region 355E, a sixth 3D interactive region 355F, a seventh 3D interactive region 355G, and an eighth 3D interactive region 355H.

In the configuration of FIGS. 3G and 3H, different regions may be logically organized to correspond to different layers, such as described above with respect to FIG. 3B. In this way, referring to FIG. 3G, regions 355A and 355D may correspond to content-agnostic layers, whereas regions 355B and 355C may correspond to content-activated layers. Additionally, or alternatively, layers in closer proximity to the sensor device may indicate urgency of the command or may be combined with a gesture to provide a new command. For example, a human user that places a hand in region 355E with an open palm out may be understood to be signaling an alert because the gesture and location indicates a “hand raise,” whereas a similar open-palm hand in region 355B may be signaling to “stop” or “pause” the content because the gesture and location indicate the user is communicating a “stop” signal. As yet another example, the whole interactive space 350 of FIG. 3H encompasses an entire room. In this case, when a human user is identified as positioned in region 355C and there is movement identified on region 355A, the system may know that a door has opened or another has entered the room. In this case, if the human user in region 355C is viewing materials marked as “confidential,” the system may automatically blur the content to protect the confidentiality. As yet another example, if that human user moves from region 355C to 355A and leaves the whole interactive space 350, the target device may be locked, the content being viewed blurred to protect privacy, the content paused (if applicable), or the (audio) volume reduced (if applicable). Then, when the human user is detected as having returned, those actions may be undone. However, if the human user returns only to region 355A, the (audio) volume may be increased over the prior volume to accommodate the location of the human user in a region 355A further away than the prior region 355C.

Other locations, or gestures, or combinations thereof may be numerous and include, as non-limiting examples, eye location, waving, swiping, pinching, un-pinching, opening arms, closing arms, winking, blinking, nodding head, shaking head, standing, sitting, entering, exiting, leaning in, leaning away, raising hand, lowering hand, and many others. These are locations and/or gestures that primarily rely on a human user. Other location-based commands or gestures may utilize, include, or be taken by non-human users. In one example, as described above, an opening door in a room may represent one non-human user (i.e., a door) that serves as a command.

Referring again to FIG. 3A, the human user 140 may also utilize a non-human user 160. The non-human user 160 may be an inanimate object, such as a wand or simple device. The non-human user 160 may also be a user device, such as described with respect to FIG. 2. For example, the non-human user 160 may be a computing device, such as a phone, table, or other computing system. In one non-limiting example, the non-human user 160 may include a display that extends the commands beyond location and gesture commands. For example, when the non-human user 160 includes a display, that display can be used to communicate dynamic information and add an additional loop to the photon-driven communications network 314 described above with respect to FIG. 3B.

In one non-limiting example, the display of the non-human user 160 may include displaying encoded content that is then received as a command or validation of a command via the human user 140. In one non-limiting example, the encoded content may be a unique identifier. For example, the unique identifier can be an encoded symbol, such as a bar code a QR code, or other encoded symbol that communicates encoded information, such as a location address of digital content, a screen position within the surface area at which the digital content is insertable in the displayed data, and/or a size of the digital content when inserted in the displayed data (adjustable before being displayed). In one configuration, the unique identifier can include a marker. The marker can take the form of patterns, shapes, pixel arrangements, pixel luma, and pixel chroma, among others. Digital content can be displayed at the surface areas, or locations in the displayed data, corresponding to the unique identifier. In one configuration, the surface areas are reference points for the relative location of digital content. In one embodiment, surface area refers to empty space wherein additional digital content can be inserted without obscuring displayed data.

In another non-limiting example, the encoded content can include a reference patch. For example, a reference patch can be encoded as a different color from a surrounding region, wherein the color of the reference patch is visually indistinguishable from the surrounding region to a human observer. It can be necessary to preserve minute color differences so that a device receiving the displayed data, such as the target device 115 of FIG. 1, can identify the reference patch. For example, the target device 115 of FIG. 1 can use a template of expected color values to identify the reference patch. The target device 115 of FIG. 1 can use the template when inspecting a frame buffer or main memory. A lossy compression algorithm that takes an average of color values may compress the difference in color between the reference patch and the surrounding region, thus effectively eliminating the reference patch from the image data. In one configuration, the image data encoding the region of the reference patch can be transported with lossless compression to preserve the reference patch. Any of a variety of different uses and operations for communicating using the human user 140 and the non-human user 160 are possible. The above provides only a few, limited, examples for illustration only.

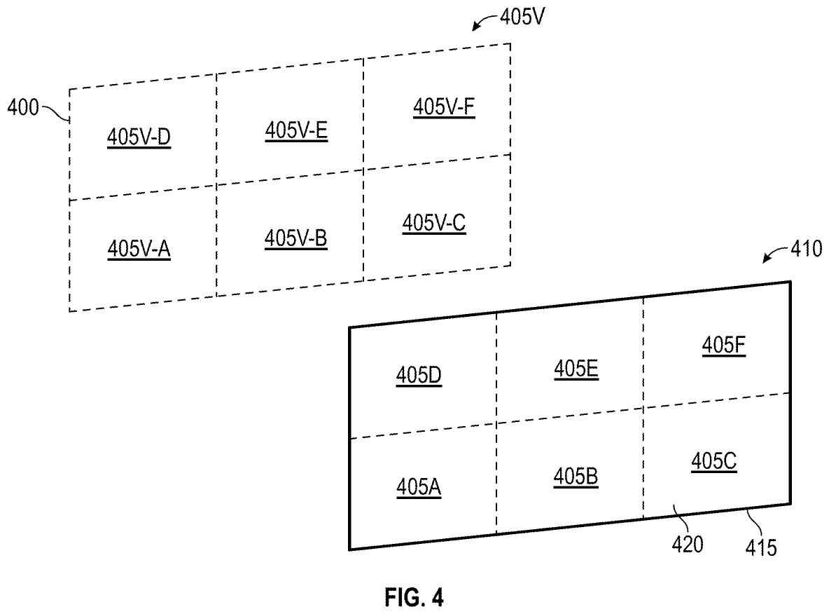

Referring now to FIG. 4, a perspective view is shown of a virtual interactive space 400 relative to a display device (e.g., the display device 217 of the target device 115) according to some configurations. As illustrated in FIG. 4, the virtual interactive space 400 includes six virtual interactive regions 405V: a first virtual interactive region 405V-A, a second virtual interactive region 405V-B, a third virtual interactive region 405V-C, a fourth interactive virtual region 405V-D, a fifth virtual interactive region 405V-E, and a sixth virtual interactive region 405V-F.

FIG. 4 also illustrates an example display device reference plane 410 for a display device (e.g., the display device 217) (referred to herein as “the display plane 410”). In the illustrated example, the display plane 410 includes a display boundary 415 representing an edge of a display region 420 of the display device 217. The display device 217 may display digital content within the display region 420. Accordingly, the display region 420 is an area or space in which digital content may be displayed to a user. As illustrated in FIG. 4, the display region 420 of the display device 217 includes six interactive regions 405: a first interactive region 405A, a second interactive region 405B, a third interactive region 405C, a fourth interactive region 405D, a fifth interactive region 405E, and a sixth interactive region 405F.

Each virtual interactive region 405V of the virtual interactive space 400 corresponds to (e.g., is a virtual projection or representation of) an interactive region 405 of the display region 420. For instance, the first region virtual interactive region 405V-A corresponds with the first interactive region 405A, the second virtual interactive region 405V-B corresponds with the second interactive region 405B, the third virtual interactive region 405V-C corresponds with the third interactive region 405C, the fourth interactive virtual region 405V-D corresponds with the fourth interactive region 405D, the fifth virtual interactive region 405V-E corresponds with the fifth interactive region 405E, and the sixth virtual interactive region 405V-F corresponds with the sixth interactive region 405F. Accordingly, displayed digital content included within an interactive region 405 is associated with a corresponding virtual interactive region 405V.

The virtual interactive space 400 may correspond to or represent the display region 420 of the display device 217. The virtual interactive space 400 is a physical space that is external to the display device 217. In other words, the virtual interactive space 400 is a physical space that exists external to the display device 217 (e.g., the user device 110). As one non-limiting example, the virtual interactive space 400 may be a virtual projection or representation of the display plane 410 (or display region 420). Accordingly, in some configurations, the virtual interactive space 400 represents a virtual reality projection of the displayed digital content. As one non-limiting example, with reference to FIG. 4, a user may interact with digital content displayed in the display region 420 (displayed via the display device 217 of the user device 110) by interacting with the virtual interaction space 400 (or a virtual interactive region 405V thereof). Accordingly, in some configurations, the virtual interaction space 400 may facilitate contactless interaction with the displayed digital content of the display region 420.

In some configurations, each interactive region may be associated with an interactive function or functionality (also referred to herein as a “function”). An interactive function may include one or more functions associated with performing a contactless interaction. In some configurations, the interactive function is associated with a software application (or the displayed digital content thereof). In some configurations, the interactive function is a standard or universal function (e.g., a function commonly understood and accepted), such as the above-described replacement for traditional commands communicated via a remote control for television or movie viewing. Alternatively, or in addition, the interactive function may be a custom or personalized function (e.g., based on a user profile).

In some configurations, the interactive function may modify the displayed digital content (or a portion thereof) (e.g., as a modification command or function). The interactive function may modify, e.g., a font property (e.g., a font, a font size, a font alignment, a font color, a font effect, a font highlighting, a font case, a font style, a font transparency, etc.), an animation property (e.g., a flashing animation, a rotation animation, etc.), a language (e.g., perform a translation from a first language to a second language), etc.

Alternatively, or in addition, in some configurations, an interactive function may control functionality associated with the displayed digital content (or a portion thereof), a software application (e.g., the software application(s) 240), or a combination thereof. As one non-limiting example, when the displayed digital content is an email management interface of an electronic communication application, the interactive function may be a reply command, a forward command, a mark-as-new command, a delete command, a categorize command, a reply-all command, a mark-as-spam command, etc. As another non-limiting example, when the displayed digital content is a movie being streamed via a video streaming application, the interactive function may be a stop command, a pause command, an exit command, a play command, a reverse command, a fast forward command, a skip forward command, a skip backward command, an enable closed captions command, a disable closed captions command, etc.

Alternatively, or in addition, in some configurations, the interactive function may launch digital content for display, a software application or program, etc. As one non-limiting example, when the displayed digital content includes a hyperlink to a website, the interactive function may be launching a web-browser and displaying the website associated with the hyperlink. As another non-limiting example, when the displayed digital content is an email with an attached file, the interactive function may be launching or opening the attached file.

Alternatively, or in addition, in some configurations, the interactive function may include a post function, a like function, a dislike function, a comment function, a mark-as-favorite function, a buy function (e.g., for purchasing goods, services, etc.), a place-bid function, a raise hand function, a close function (e.g., for closing a dialogue box or window), an exit function (e.g., for exiting an open software application), a vote function (e.g., for submitting a vote), an enter or submit function, an upload function (e.g., for uploading an electronic file or digital content), a leave function (e.g., for leaving a teleconference call or meeting), a mute function (e.g., for muting input audio, output audio, or a combination thereof associated with an open software application), a volume control function (e.g., for adjusting a volume associated with an audio output), etc.

Accordingly, in some configurations, an interactive function may include functionality associated with interactions performed with another type of peripheral that has a wired connection, a wireless connection, or a combination thereof with the user device 110 of FIG. 1 (e.g., interactions performed with a cursor control device, such as a mouse).

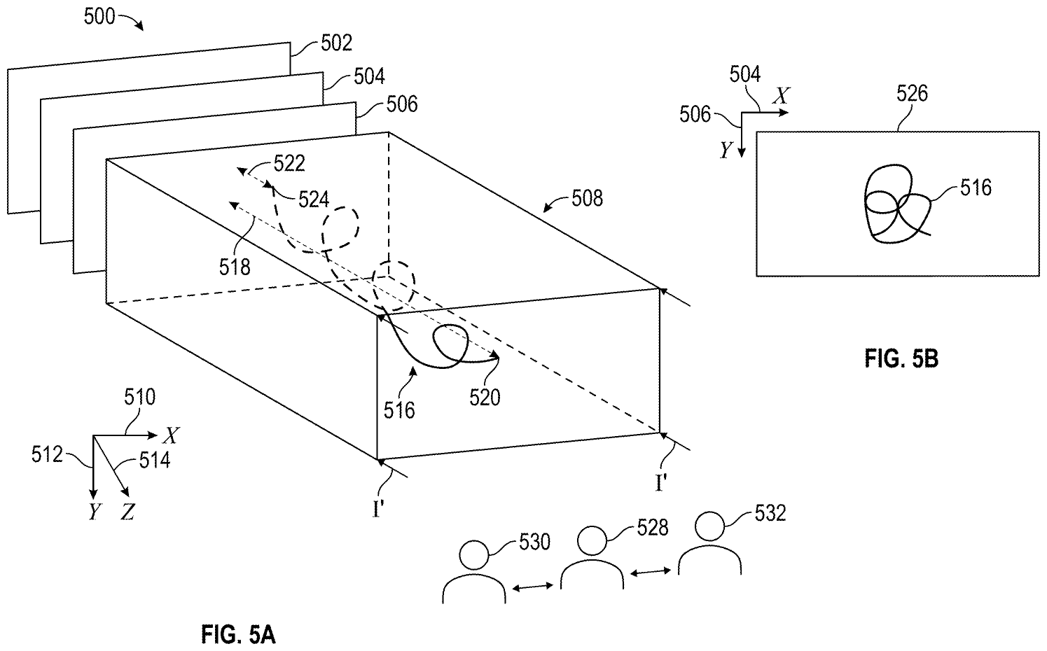

FIG. 5A is a perspective view of a graphical user interface (GUI) 500 including a three-dimensional virtual interactive space 508. In some examples, the device 110, 115 can display, via the display device 217, a user interface (e.g., a graphical user interface (GUI) 500). The GUI 500 can include multiple layers of screens to provide multi-layered visual experience. The GUI 500 enables managing, manipulating, and merging multiple layers of content into a single computing experience. In other words, multiple layers can be superimposed and displayed transparently and simultaneously within the same window of the display device 217. In some examples, a layer refers to digital data displayed in a window of the device 110, 115. In further examples, a window refers to the viewing area of a display/screen of the display device 217. In some embodiments, this is accomplished by adjusting a transparency of pixels in one or more layers to achieve a semi-transparent effect relative to other simultaneously displayed layers. That way, any number of simultaneous media sources can be displayed in a window such that the blended input media can optically appear to exist either in front of or behind other layers. In some embodiments, the level of transparency of the layers is user or non-human adjustable to further emphasize content on a superimposed layer over fading content of an underlying layer. For example, as the level of transparency of the superimposed layer increases, the device 110, 115 can adjust the color or contrast of the pixels of content on the superimposed layer to be more similar to those on the underlying layer (e.g., by aggregating overlapping pixels between the superimposed layer and the underlying layer). In further examples, as the level of transparency of the superimposed layer decreases, the device 110, 115 can adjust the color or contrast of the pixels of content on the superimposed layer less to display the original color or contrast of the pixels of content on the superimposed layer more and the pixels of the underlying layer less.

In some examples, the GUI 500 may include a first layer 502, which is a background layer. In some examples, the first layer 502 may include a background image or video. For example, the first layer 502 may display a background scene or environment. In other examples, the first layer 502 may include an existing GUI, which includes a GUI screen on an operating system software (e.g., Microsoft® Windows®, macOS®, Android®, or any other suitable operating system software) stored in the memory 205. In some examples, various content can be displayed on the existing GUI. For example, the content displayed on the existing GUI of the first layer can include one or more pictures, numbers, letters, symbols, icons, videos, graphs, and/or any other suitable data. As an underlying layer, the image, data, content, or information displayed on the first layer 502 is superimposed by one or more superimposed layers (e.g., a second, third, and/or fourth layer). Thus, the device 110, 115 may blur, hide, or make opaque the data or content displayed on the first layer 502 for the one or more superimposed layers. In some examples, although the first layer 502 is an underlying layer disposed below the one or more superimposed layers, the device 110, 115 may make the first layer 502 not transparent for the user to clearly see the data or content displayed on the first layer 502 (e.g., based on a request by the user, a condition, or a system configuration). It should be appreciated that the first layer 502 may be an optional layer and might not be included in the GUI 500 or may be a transparent layer. In other examples, the device 110, 115 may generate and/or delete the first layer 502 (e.g., upon a request by the user 140).

In further examples, the GUI 500 may include a second layer 504, which is a data stream layer. In some examples, the second layer 504 is a superimposed layer over the first layer 502. The data stream in the second layer 504 can be transparent, partially transparent (i.e., translucent), or opaque (e.g., based on an automatic or manual configuration). If the second layer 504 is opaque, the device 110, 115 can display the data stream but does not display the image, data, content, or information of the first layer 502. In some examples, the device 110, 115 may receive and display on the second layer 504 a data stream of image data from the imaging device 219 and/or the communication interface 210. In further examples, the data stream of image data may include the user 140 (i.e., an image of the user 140 displayed on the second layer). For example, the data stream of image data can show an object. The object can include a body part (i.e., an image of the body part displayed on the second layer) of the user. The body part can include one or two hands, one or two arms, the head, the torso, one or two legs, the whole body, etc. Thus, the device 110, 115 may display the user 140 on the second layer 504 of the GUI 500.

However, it should be appreciated that the object is not limited to a body part (i.e., an image of the body part displayed on the second layer). For example, the object can include any suitable non-human object (e.g., a stick, a ball, or any suitable object). Then, the device 110, 115 may identify the object in the data stream of image data. In some examples, the device 110, 115 may identify the object displayed on the second layer 504. In further examples, the device 110, 115 may determine a set of characteristics of the object. In some examples, the set of characteristics of the object may include a shape of the object, a movement of the object, an orientation of the object, a position of at least a part of the object, a gesture, or any other suitable characteristics of the object. For example, the device 110, 115 may determine the gesture of the hand of the user. In further examples, the device 110, 115 may determine the location (i.e., the set of characteristics) of the head or the eye (i.e., object) of the user. In further examples, the set of characteristics may include the eye location, waving, swiping, pinching, un-pinching, opening arms, closing arms, winking, blinking, nodding head, shaking head, standing, sitting, entering, exiting, leaning in, leaning away, raising hand, lowering hand, and many others. These primarily rely on a human user. Other sets of characteristics may be based on non-human users. For example, the set of characteristics based on non-human users may include an opening door in a room.

In some examples, the device 110, 115 can display more than one data stream of image data to include more than one corresponding users on the second layer 504. For example, the device 110, 115 can display a live video of the user and one or more other live videos of the one or more other users on the second layer 504 of the GUI 500 joining a video conference. In the examples, the device 110, 115 can identify other objects for other users and determine sets of characteristics of the other objects for other users joining the video conference. It should be appreciated that the second layer 504 may be an optional layer and might not be included in the GUI 500 or may be a transparent layer. In other examples, the device 110, 115 may generate and/or delete the second layer 504 (e.g., upon a request by the user 140).

In further examples, the GUI 500 may include a third layer 506, which is a digital content layer. In some examples, the third layer 506 is a superimposed layer over the first layer 502 and/or the second layer 504. The digital content in the third layer 506 can be transparent, partially transparent (i.e., translucent), or opaque (e.g., based on an automatic or manual configuration). If the third layer 506 is opaque, the device 110, 115 can display the digital content but does not display the first layer 502 and the second layer 504. In some examples, the device 110, 115 may display the digital content, which is stored in the memory 205 and/or is received via the communication interface 210. Digital content generally refers to electronic data or information. The digital content may include, for example, a word processor document, a diagram or vector graphic, a text file, an electronic communication (for example, an email, an instant message, a post, a video message, or the like), a spreadsheet, an electronic notebook, an electronic drawing, an electronic map, a slideshow presentation, a task list, a webinar, a video, a graphical item, a code file, a web site, a telecommunication, streaming media data (e.g., a movie, a television show, a music video, etc.), an image, a photograph, and the like. The digital content may include multiple forms of content, such as text, one or more images, one or more videos, one or more graphics, one or more diagrams, one or more charts, and the like. For example, the device 110, 115 may generate the third layer displaying a slide (e.g., based on a request from the user 140). In other examples, the device 110, 115 may generate the third layer displaying a slide to share the slide with other users in the video conference. In further examples, the device 110, 115 may allow the user 140 and/or other users to access and edit the digital content on the third layer 506. It should be appreciated that the third layer 506 may be an optional layer and might not be included in the GUI 500 or may be a transparent layer. In other examples, the device 110, 115 may generate and/or delete the third layer 506 (e.g., upon a request by the user 140).

In further examples, the GUI 500 may include a fourth layer, which is a three-dimensional virtual interactive space 508. In some examples, the three-dimensional virtual interactive space 508 refers to a computer-simulated place including X 510, Y 512, and Z 514 axes while the first, second, and third layers 502, 504, 506 are two-dimensional planes with X and Y axis 510, 512. In the three-dimensional virtual interactive space 508, a plane with X axis 510 and Y axis 512 may correspond to the window or the viewing area of the display device 217. In some examples, the three-dimensional virtual interactive space 508 can further include an additional dimension with Z axis 508. Thus, the three-dimensional virtual interactive space 508 can include multiple planes with X and Y axes 510, 512 with multiple corresponding depths in Z axis 512. In some examples, a depth refers to a distance from a reference X-Y plane at a right angle in Z axis 514. In some examples, the reference X-Y plane may be a X-Y plane, which meets an underlying layer (e.g., the third layer 506, the second layer 504, or the first layer 502) of the GUI 500. However, it should be appreciated that the reference X-Y plane may be a X-Y plane, which is most distant from the underlying layer, or any other suitable X-Y plane on X axis. In some examples, the distance from the reference X-Y plane may not be to scale because the distance on Z axis 514 in the three-dimensional virtual interactive space 508 is not a physical distance but a virtual distance represented on the viewing area (e.g., a two-dimensional screen) of the display device 217.

In further examples, the three-dimensional virtual interactive space 508 may include a form 516. In some examples, the form 516 may include a line, a triangle, a square, a polygon, a cylinder, a cube, a cuboid, a polyhedron, any two-dimensional suitable object, and/or a three-dimensional suitable object. For example, the form 516 may be a three-dimensional line with different depths. In some scenarios, a first depth 518 of one end 520 of the three-dimensional line (i.e., the form 516) may be different from a second depth 522 of the other end 524 of the three-dimensional line. In some examples, when the device 110, 115 displays the form 516 on the X-Y plane 526 to be shown in FIG. 5B, the device 110, 115 displays the form 516 as the form 516 does not have different depths. Thus, the form 516 is projected on the X-Y plane 526 without showing any depth on the Z axis 514.

In further examples, the device 110, 115 displays the different depths of the form 516. For example, the device 110, 115 displays the different depths of the form 516 by displaying a front-side view (e.g., 15®, 30®, 45®, or any other suitable viewing angle to the X-Y plane) of the form 516. In some examples, the device 110, 115 may display the different depths of the form 516 based on the set of characteristics of the object (e.g., the location of the head or eye). For example, when the user 140 is located at the center 528 of the display, the device 110, 115 may identify the head or eye of the user 140 displayed on the second layer and determine the location of the head or eye of the user 140, which is at the center location 528 of the second layer 504. Then, the device 110, 115 may display the form 516 to be projected on the X-Y plane 526 without showing any depth of the form 516 as shown in FIG. 5B.

When the user 140 moves toward a first side 530 of the display, the device 110, 115 may identify the head or eye of the user 140 displayed on the second layer and determine the location of the head or eye of the user 140, which is at the first side 530 of the second layer 504. Then, the device 110, 115 may display the form 516 such that a first part of the form 516 with a first depth, which is far from the second layer 504, is displayed to move from the center of the display to a second side (i.e., an opposite side to the first side) of the second layer 504 while a second part of the form 516 with a second depth, which is close to the second layer 504, is displayed to move less than the first part of the form 516. Thus, when the user 140 is at the first side 530 of the second layer 504, the first part of the form 516 is displayed relatively at the second side of the second layer 504 while the second part of the form 516 is displayed relatively at the center location of the display.

Similarly, when the user 140 is at the second side 532 of the display, the device 110, 115 may display the form 516 such that the first part of the form 516 with the first depth is displayed on the first side of the GUI 500 while the second part of the form 516 with the second depth is displayed at the center of the GUI 500. Thus, the device 110, 115 may display different depths of the form 516 in response to the location of the user 140. It should be appreciated that displaying different depths of the form 516 may be in a different way. For example, when the user 140 is at the first side 530 of the display, the device 110, 115 can display the second part of the form 516 with the second depth is displayed on the second side 532 of the display while the first part of the form 516 with the first depth is displayed at the center of the display.

In some examples, the device 110, 115 may generate a form 516 in the three-dimensional virtual interactive space 508 in response to the set of characteristics of the object. In some examples, the device 110, 115 can identify the object (e.g., a hand) in the data stream of image data. Then, the device 110, 115 can determine first and second sets of characteristics of the object based on the identification of the object. In some examples, the first and second sets of characteristics of the object may include first and second positions of the object, respectively. The device 110, 115 can generate the form 516 by tracking movement of the object from the first position to the second position of the object. For example, the user 140 in the data stream of image data raises a hand and poses a pinching finger gesture to move two fingers to be closer together. The device 110, 115 can identify the pinching finger gesture and determine a location of the pinch, which is a point being touched between two fingers. In some examples, the point being touched between two fingers is a start point 520 to start generating form 516. Then, the device 110, 115 tracks the points being touched between two fingers in the data stream of image data and generates the form 516 (e.g., by drawing a line between the tracked points). The device 110, 115 can stop generating the form 516 at the end point 524 when the pinching finger gesture is no longer identified. In further examples, in response to the identified pinching finger gesture, the device 110. 115 may perform any other action(s).

In some examples, the device 110, 115 may recognize the pinching finger gesture as a command to start generating a line (i.e., the form 516) from the location of the pinch. The device 110, 115 may generate the line by tracking movement of the location of the pinch. The device 110, 115 may stop generating the line when the device 110, 115 identifies a releasing finger gesture, which is a gesture to release two fingers from the pinching finger gesture. It should be appreciated that the form is not limited to the line as shown in FIG. 5. For example, the device 110, 115 can generate any other form (e.g., a triangle, a square, a polygon, a cylinder, a cube, a cuboid, a polyhedron, a human, a non-human object, any two-dimensional suitable object, and/or a three-dimensional suitable object) in the three-dimensional virtual interactive space. Also, the pinching and releasing finger gestures are mere examples to start and stop generating the form. For examples, the device 110, 115 can recognize any other suitable finger/body gesture, sound, keyboard input, mouse click, or any suitable input as the command to start and stop generating the form.

In some examples, the device 110, 115 can determine depths of the form 516 corresponding to first and second positions of the object, respectively. In some examples, the device 110, 115 can determine depths of the form 516 based on a generation time of the form 516. For example, when the device 110, 115 generates the form 516 from a first point 520 to a second point 524, the depths at the first point 520 and the second point 524 of the form 516 can correspond to the times to generate the form 516 at the first point 520 and the second point 524, respectively. In some scenarios, the depth of the form 516 can be closer to the reference plane as the form is generated. In other scenarios, the depth of the form 516 can be farther from the reference plane as the form is generated.

In other examples, the device 110, 115 can determine depths of the form 516 based on the speed to move the object from the first position to the second position. For example, the device 110, 115 can increase (or decrease) the depth of the form 516 when the movement speed of the object increases while the device 110, 115 can decrease (or increase) the depth of the form 516 when the movement speed of the object decreases. In further examples, the device 110, 115 can determine the same depth for each form 516. For example, when the device 110, 115 generates a letter ‘H’ (i.e., the form), the letter ‘H’ has a first depth, and the entire letter ‘H’ has the same depth. When the device 110, 115 generates letters ‘E,’ ‘L,’ ‘L,’ and ‘O’ (i.e., other forms 516), the letters ‘E,’ ‘L,’ ‘L,’ and ‘O’ have second, third, fourth, and fifth depths, respectively. In some examples, each letter has the same depth and all five letters have the same depth (the first, second, third, fourth, and fifth depths are the same) or different depths. In further examples, when the device 110, 115 is generating a form 516, the form 516 has the same depth. However, when the device 110, 115 stops generating a form 516, the device 110, 115 can determine the depths of the form 516. In even further examples, when the device 110, 115 is generating multiple forms 516, the multiple forms 516 may have the same depth. However, when the device 110, 115 stops generating the forms 516, the device 110, 115 can determine the depths of the multiple forms 516 (e.g., all forms 516 having different depths or the same depth, and/or a form having different depths or the same depth).

In further scenarios, the device 110, 115 may generate the form 516 on a two-dimensional plane first and reconstruct or expand the form 516 on a three-dimensional place based on the generation time of the form, the shape of the form, the location of the form, and the like. It should be appreciated that the depths of the form 516 can be determined in any other suitable way. In some examples, the device 110, 115 can determine first and second depths of the form 516 based on the size of the object displayed on the GUI 500 (i.e., the second layer 504). For example, when the size of the hand of the user 140 displayed on the second layer 504 becomes bigger (e.g., by moving the hand to be closer to the imaging device 219), the depth of the form 516 may become deeper (e.g., become farther from the reference plane like a point 520 of the form 516). On the other hand, when the size of the hand of the user 140 displayed on the second layer 504 becomes smaller (e.g., by moving the hand to be farther away from the imaging device 219), the depth of the form 516 may become shallower (e.g., become farther from the reference plane like a point 524 of the form 516).

In further examples, the device 110, 115 can generate any other suitable form than the example line as shown in FIGS. 5A and 5B. In some examples, the device 110, 115 can generate a three-dimensional shape (e.g., a sphere, a cylinder, a cone, a polygonal pyramid, a polygonal prism, a cube, a cuboid, etc.) based on the process described above. In further examples, the device 110, 115 can generate a three-dimensional object (e.g., user's three-dimensional skeleton or user's body, which can copy the user's movement displayed on the second layer 504).

In further examples, the device 110, 115 may manipulate (e.g., erase or reconstruct) a part of the form 516 (e.g., in response to an input). For example, the GUI 500 may include a history indicator (e.g., a slide or any other suitable indicator to show the timeline from the time to generate the form 516 to the current time or the time to stop generating the form 516). In some examples, the slider may indicate the form generation timeline from the time to start generating the form 516 to the current time or the time to stop generating the form 516. In some examples, the user may move backward or forward to any particular point on the slider to erase or reconstruct the form 516 associated with the particular point. For example, the user may move the slider backward to a first point on the sliding bar to erase a portion of the form 516 from the three-dimensional virtual interactive space. The first point on the sliding bar may indicate a particular time between the time to generate the form 516 and the current time or the time to stop generating the form 516. In response to the user moving the slider to the first point, the device 110, 115 erases a portion of the form 516 generated from the particular time to the current time or the time to stop generating the form 516. In some examples, the device 110, 115 may store the erased portion of the form 516 in a temporary memory space. In other examples, the device 110, 115 does not display the erased portion of the form 516. When the user moves the slider from the first point to a second point indicating the current time or the time to stop generating the form 516, the device 110, 115 reconstructs the erased portion of the form 516. In other examples, the user keeps generating the form 516 from the first point on the sliding bar.

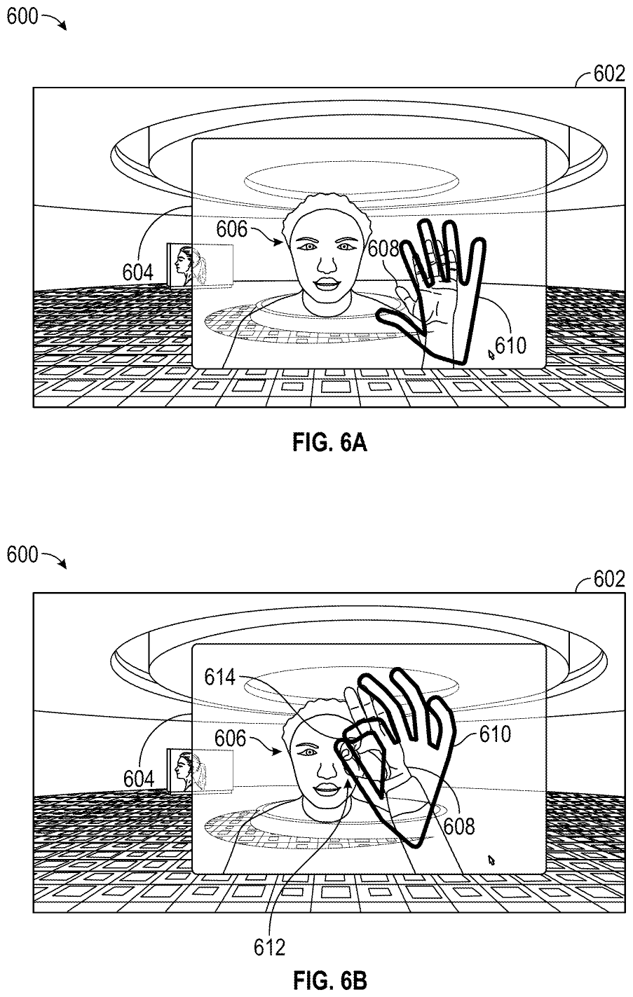

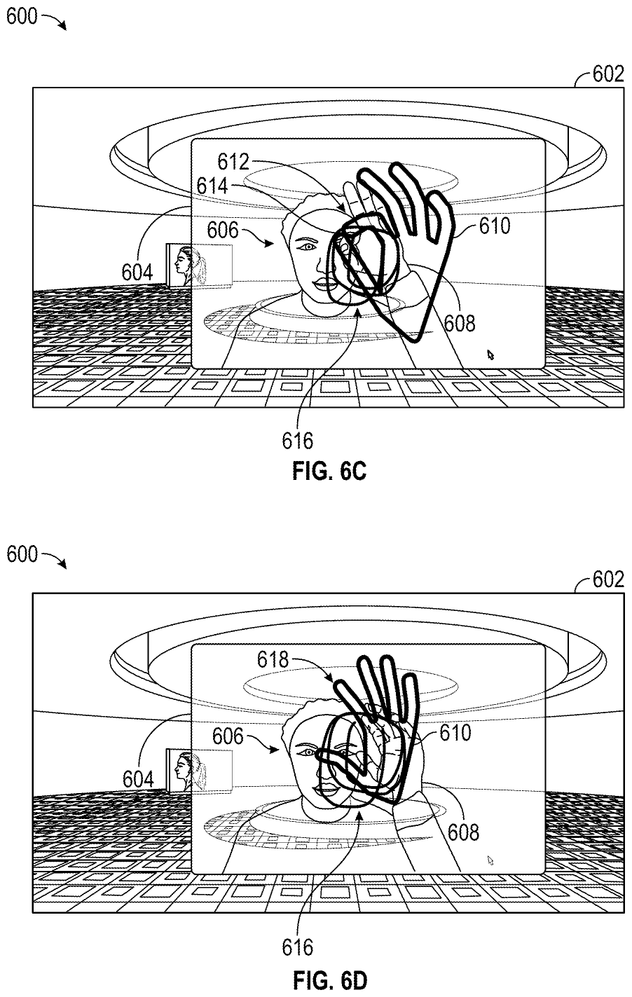

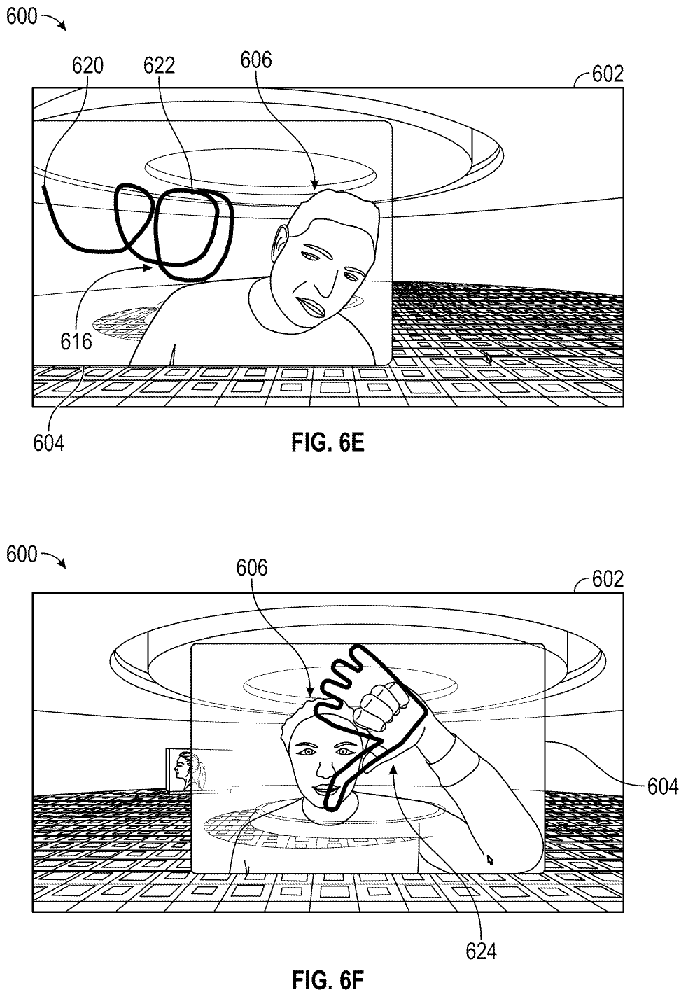

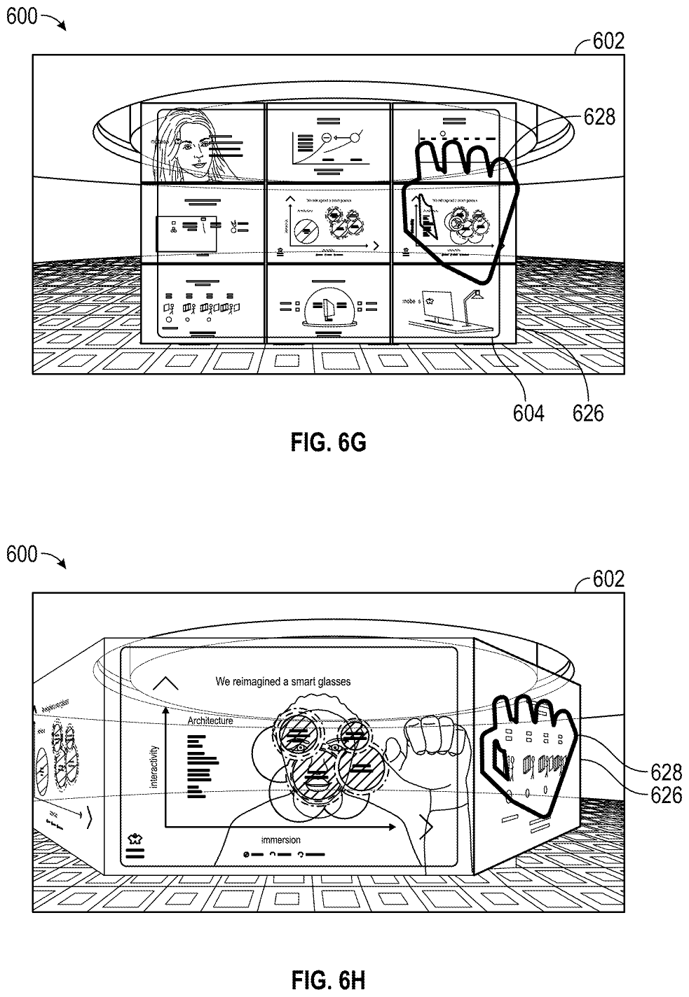

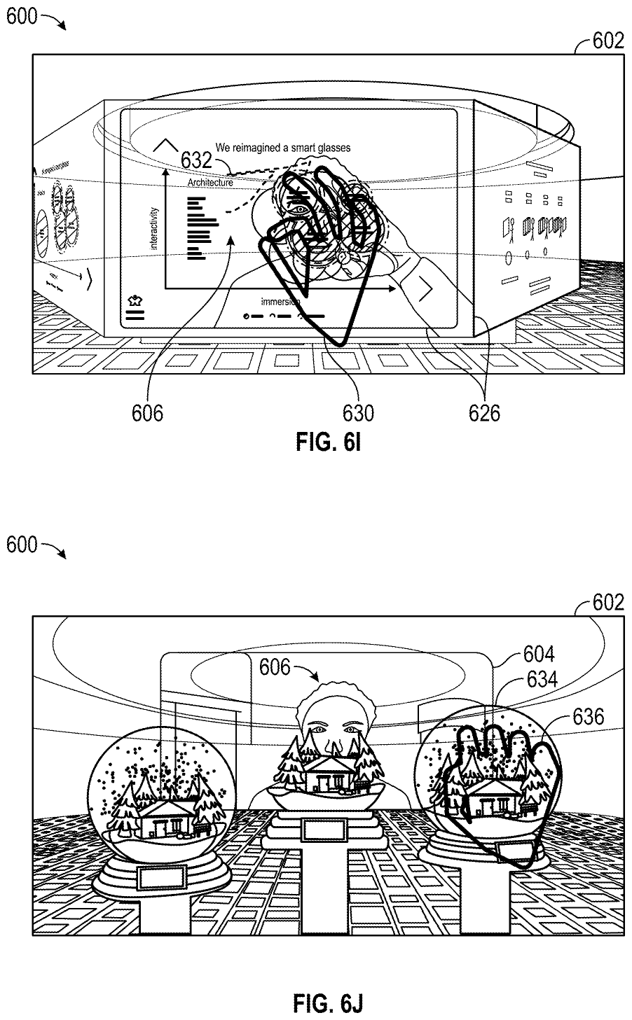

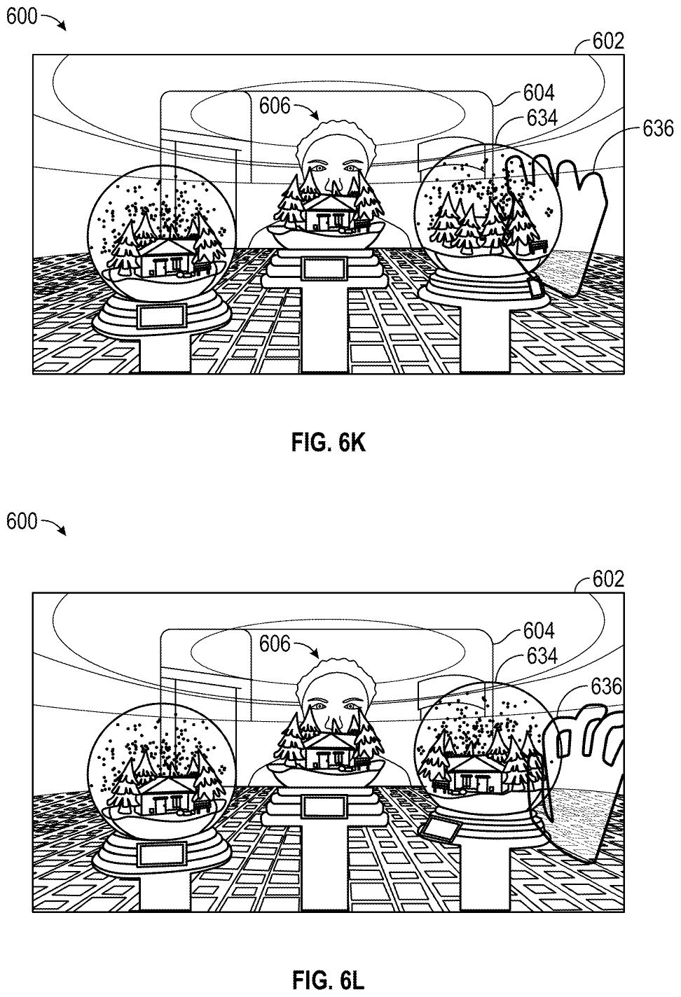

FIGS. 6A-6I illustrate interaction in a three-dimensional virtual interactive space according to some configurations. Referring to FIG. 6A, a GUI 600 is shown. The GUI 600 may include a background layer 602 (i.e., the first layer 502 in FIG. 5A). In some examples as shown in FIG. 6A, the background layer 602 may show a virtual room to indicate that a user 140 is in the virtual room. The GUI 600 may also include a data stream layer (i.e., the second layer 504 in FIG. 5A), which is a superimposed layer over the background layer 602. The data stream layer 604 may show a data stream of image data including a user 606. As described above, the data stream layer 604 may show other data stream(s) of image data including other user(s) who join a video conference. In some examples, the data stream layer 604 may include multiple panels to display multiple users.

In further examples, the device 110, 115 can identify a displayed hand 608 of the user 606 (i.e., an object) displayed on the data stream layer 604. It should be appreciated that the displayed hand 608 is a mere example. In some examples, the device 110, 115 can identify or detect any other suitable object displayed on the data stream layer 604. In further examples, the device 110, 115 can display the data stream layer 604 to be smaller than the background layer 602. However, it should be appreciated that the data stream layer 604 may be displayed to be the same as the background layer 602. The GUI 600 may also include a three-dimensional virtual interactive space (i.e., the fourth layer 508 in FIG. 5A), which is a superimposed layer over the background layer 602 and the data stream layer 604. The device 110, 115 can display a virtual hand 610 corresponding to the displayed hand 608 in the three-dimensional virtual interactive space. In some examples, the virtual hand 610 is a simplified and mirrored two-dimensional image of the displayed hand 608. It should be appreciated that the virtual hand 610 is a mere example and can be any other suitable virtual object corresponding to the displayed hand 608.

Referring to FIG. 6B, the device 110, 115 can determine a hand gesture 612 (i.e., a set of characteristics) of the hand 608 to perform a form generation procedure. For example, the device 110, 115 can identify a pinching finger gesture 612 of the displayed hand 608 and display a corresponding pinching finger gesture 612 of the virtual hand 610. When the device 110, 115 identifies the pinching finger gesture 612 (i.e., the set of characteristics), the device 110, 115 may recognize the pinching finger gesture 612 as a line drawing command and start generating a line (i.e., a form) from a point 614 where the two fingers touch in the three-dimensional virtual interactive space.

Referring to FIG. 6C, the device 110, 115 can track the movement of the hand 608 based on the hand gesture (i.e., a set of characteristics) of the hand 608 and generate a form. For example, the device 110, 115 can track the movement of the pinching finger gesture 612 (i.e., the hand gesture) of the virtual hand 610 and draw a line 616 (i.e., a form) in the three-dimensional virtual interactive space. The line 616 is in the three-dimensional virtual interactive space, which is a superimposed layer over the background layer 602 and the data stream layer 604.

Referring to FIG. 6D, the device 110, 115 can stop generating the form based on a different hand gesture (i.e., a set of characteristics) of the displayed hand 608 and generate a form. For example, the device 110, 115 can identify a releasing hand gesture 618 on the data stream layer 604. In response to the releasing hand gesture 618, the device 110, 115 may stop generating the line 616 (i.e., the form).

Referring to FIG. 6E, the device 110, 115 can identify a first location of a second object (e.g., the head or eye of the user) in the third data stream, the first location of the head being different from a second location of the second object in the first data stream. The device 110, 115 may display the form with the different depths on the display. In some examples, the form 616 displayed based on the second location of the second object may have a different shape from the form displayed based on the first location of the second object. Thus, when the user 606 moves the head to a side (e.g., the left side or the right side) of the data stream layer 604, the form 616 shows its depths of the form 616 while the form 606 does not show the depths of the form 606 when the user 606 is at the center of the of the data stream layer 604. Thus, the form 616 is displayed in a different shape due to the depths of the form 616 based on the location of the user 606. In further examples, when the user 606 moves the head to a side (e.g., the left side or the right side) of the data stream layer 604, the device 110, 115 can move the data stream layer 604 to the other side on the background layer 602 for the head of the user 606 to be placed at the center of the GUI 600. In further examples, the device 110, 115 may detect the size of the second object (e.g., the head or eye of the user 606). Then, the device 110, 115 may magnify the form when the size of the second object becomes bigger and reduce the form when the size of the second object becomes smaller.

For example, the device 110, 115 may identify movement of the head of the user 606 to a side of the data stream layer 604. In some examples, the device 110, 115 may move the data stream layer 604, which is included in and is disposed over the background layer 602, such that the head of the user 606 is placed at the center of the GUI 600 although the head of the user 606 is at the side of the data stream layer 604. As the head of the user 606 moves to the side of the data stream layer 604, the device 110, 115 may display a first part 620 of the form 616, which has more depths or far from the data stream layer 604, to move to the other side of the data stream layer 604 farther than the second part 622 of the form 616 which has less depths or close to the data stream layer 604.

In some examples, the device 110, 115 may distinguish the depths of the form 616 using different colors and/or different shapes. For example, the device 110, 115 may display the first part 620 of the form 616 with a first color (e.g., the white color or any other suitable color) and the second part 622 of the form 616 with a second color (e.g., the blue color or any other suitable color). In further examples, the device 110, 115 may gradually change the first color to the second color in the form 616. In further examples, the device 110, 115 may display the first part 620 of the form 616 with a shape (e.g., a thick line or any other suitable shape) and the second part 622 of the form 616 with a second shape (e.g., a thin line or any other suitable shape). In further examples, the device 110, 115 may gradually change the first shape to the second shape in the form 616. Thus, the device 110, 115 may display depths of the form 616 in the three-dimensional interactive space and have an effect that the user 606 see a side of the form 616 when the head of the user 606 moves toward a side of the data stream layer 604. In other examples, as the head of the user 606 moves to the side of the data stream layer 604, the device 110, 115 may display the second part 622 of the form 616 which has less depths or close to the data stream layer 604 to move to the other side of the data stream layer 604 farther than the first part 620 of the form 616, which has more depths or far from the data stream layer 604.

Referring to FIG. 6F, the device 110, 115 may remove the form based on a different hand gesture (i.e., a set of characteristics) of the hand 608 and generate a form. For example, the device 110, 115 may identify a new hand gesture 624 (e.g., a thumb-down finger gesture, or any other suitable gesture) on the data stream layer 604. In response to the new hand gesture 624, the device 110, 115 may delete or remove the line (i.e., the form).

Referring to FIG. 6G, the device 110, 115 may control digital content on a digital content layer 626 (i.e., the third layer 506 in FIG. 5A) using a virtual hand 628 displayed in the three-dimensional virtual interactive space. For example, the device 110, 115 may display digital content on the digital content layer 626, which is a superimposed layer over the background layer 602 and the data stream layer 604 but an underlying layer to the three-dimensional virtual interactive space. In some examples, the device 110, 115 may display multiple content (e.g., slides, graphs, word documents, etc.) on the digital content layer 626. The device 110, 115 may identify a hand gesture 628 (e.g., a grab gesture, or any other suitable gesture), which is a set of characteristics of the object, on the data stream layer 604 and display a corresponding virtual hand gesture 628 (e.g., with a two-dimensional drawing) in the three-dimensional virtual interactive space. The device 110, 115 may recognize the virtual hand gesture 628 as a selecting command of digital content on the digital content layer 626 based on the location of the hand gesture 628. Thus, although the virtual hand gesture 628 in the three-dimensional virtual interactive space and the digital content on the digital content layer 626 are in different layers of the GUI 600, the device 110, 115 may allow the virtual hand gesture 628 in the three-dimensional virtual interactive space to access the digital content on the digital content layer 626. In further examples, the device 110, 115 may select digital content on the digital content layer 626 in a different way as shown in FIG. 6G or 6H.

Referring to FIG. 6I, the device 110, 115 may enlarge the selected digital content in FIG. 6G or 6H on the digital content layer 626. In some examples, the device 110, 115 may identify a hand gesture 628 (e.g., a pinching finger gesture, or any other suitable gesture), which is a set of characteristics of the object, on the data stream layer 604 and display a corresponding virtual hand gesture 628 (e.g., with a two-dimensional drawing) in the three-dimensional virtual interactive space. Then, the device 110, 115 may recognize the virtual hand gesture 630 as a form generation command in the three-dimensional virtual interactive space. Since the device 110, 115 displays the form 632 generated by the virtual hand gesture 628 in the three-dimensional virtual interactive space over the digital content layer 626, the device 110, 115 may generate the drawings 632 (i.e., a form) to be displayed over the digital content (e.g., a slide) on the digital content layer 626.

Referring to FIGS. 6J-6L, the GUI 600 is displayed as a time series to show movement of a form based on the set of characteristics of an object (e.g., a hand). Referring to FIG. 6J, the three-dimensional virtual interactive space may include a globe 634 (i.e., a form). The device 110, 115 may detect a hand (i.e., an object) in the data stream layer and display a virtual hand corresponding to the hand of the user 606 in the three-dimensional virtual interactive space. In some examples, the device 110, 115 can determine a grab gesture of the hand and display a virtual grab gesture 636 over the globe 634 (i.e., a set of characteristic). The device 110, 115 may recognize the virtual grab gesture 636 over the globe 634 as a command to select the globe 634. Referring to FIG. 6K, the device 110, 115 may detect the movement of the grab gesture of the hand and display the movement of the virtual grab gesture 636 of the virtual hand. In some examples, in response to the movement of the virtual grab gesture 636 (i.e., set of characteristics), the device 110, 115 moves or spins the globe 634. Referring to FIG. 6L, the device 110, 115 can determine a release gesture of the hand and display a virtual release gesture 638. In some examples, the device 110, 115 may calculate the speed of the movement of the grab gesture of the hand until the release gesture. Based on the speed of the movement, the device 110, 115 may keep spinning or moving the globe 634. Thus, the three-dimensional form can be manipulated, moved, or affected according to real-world characteristics (e.g., speed, force, gravity, etc.). It should be appreciated that the movement of a form based on characteristics of an object is not limited to the example described above. For example, the virtual hand can straighten the line 616 shown in FIGS. 6C-6D by grabbing two ends of the line 616 using the virtual hands and straightening the line 616. In other examples, the virtual hand can grab and move the line 616 to a different location of the GUI 600. In further examples, the virtual hand can drop the globe 634 to the floor and/or throw the globe 634 to the air.

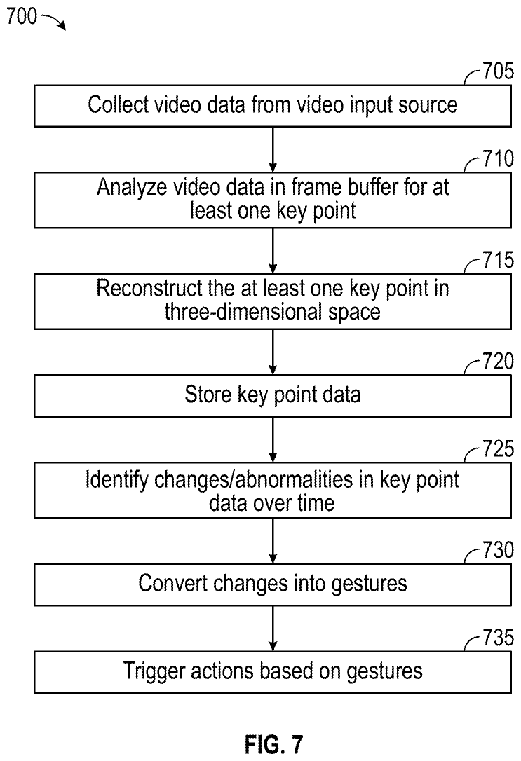

FIG. 7 illustrates an overview of a method 700 for identifying and responding to an interaction in video data using frame buffer intelligence. First, the target device 115 can identify a video input source, e.g., a webcam connected to, embedded in, or a part of the target device 115, and collect video data from the video input source in step 705. The video data can be displayed by the target device 115. The target device 115 can then analyze the video data from the video input source in a frame buffer in step 710. The frame buffer can be a frame buffer of the video input source. In one embodiment, the analysis can include the identification and categorization of at least one key point in the video data by the target device 115, wherein the at least one key point can be used to execute an interaction. For example, if the video data includes video footage of a human, key points can include body parts and/or facial features that can be used to make gestures in 3D space.

The target device 115 can use the video data to reconstruct the at least one key point in 3D space in step 715 for more accurate analysis of movement of the key points. In one embodiment, the reconstruction of a key point in 3D space can include creating at least one three-dimensional model of the key point. The model can be, for example, a virtual object with properties corresponding to and interacting with 3D space. In one embodiment, the model can be an interactive model. In one embodiment, the reconstruction of a key point in 3D space can include identifying a location of the key point in 3D space, including a depth and/or distance from the camera, using the video data. The target device 115 can store data values related to the key points in step 720 to track the key points over time. For example, the key point data can correspond to properties of a three-dimensional model of a key point. In an example embodiment, the key point data can be stored in the main memory of the device. The target device 115 can then identify changes in the key point data over time in step 725. The changes in the key point data can be analyzed and categorized as movements or gestures made by the at least one key point in step 730, wherein the gestures are used to interact with the target device 115. In step 735, the target device 115 can then trigger actions in response to the identified gestures.

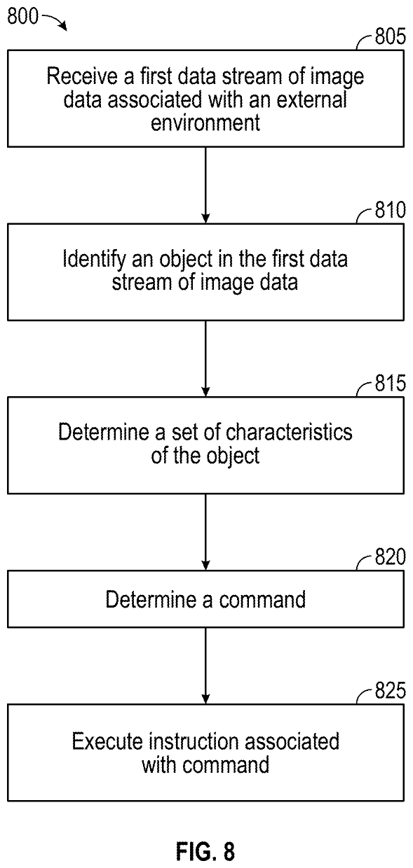

FIG. 8 is a flowchart illustrating a method 800 for implementing contactless interactions according to some configurations described herein. The method 800 is described as being performed by the target device 115 of FIG. 1 and, in particular, the photonic peripheral application 245 as executed by the electronic processor 202. However, as noted above, the functionality described with respect to the method 800 may be performed by other devices, such as the user device 110, or distributed among a plurality of devices, such as a plurality of servers included in a cloud service (e.g., a web-based service executing software or applications associated with a platform, service, or application).

As illustrated in FIG. 8, the method 800 includes receiving, with the electronic processor 202 of FIG. 2, a first data stream of image data associated with an external environment (at block 805). In some configurations, the electronic processor 202 receives the first data stream of image data from the imaging device(s) 219, the sensor(s) 230, or a combination thereof. As noted herein, the imaging device(s) 219, the sensor(s) 230, or a combination thereof collect data associated with an external environment from the target device 115 of FIG. 1. In some configurations, the electronic processor 202 of FIG. 2 may receive the first data stream of image data from another component, such as another component of the target device 115 of FIG. 1, a remote component or device (e.g., a security camera located within the proximity of the target device 115), or the like.

The electronic processor 202 of FIG. 2 may identify an object in the first data stream of image data (at block 810). An object may include a user (or a portion thereof), a non-human user (or a portion thereof), or the like. In some configurations, the electronic processor 202 may detect more than one object. As one non-limiting example, the electronic processor 202 may detect a user's left-hand as a first object and a user's right-hand as a second object. Furthermore, the user's right-hand may be holding a phone or other non-human user. To this point, as non-limiting example, the electronic processor 202 may detect a first user as a first object and a second user as a second object. As yet another non-limiting example, the electronic processor 202 may detect a human user as a first object, a door as a second object, a clock as a third object, and a dog as a fourth object.

In some configurations, the electronic processor 202 may identify the object using one or more CV techniques (e.g., one or more of the CV models stored in the memory 205). For instance, in some configurations, the electronic processor 202 analyzes the first data stream of image data using a CV model (e.g., stored in the memory 205). Alternatively, or in addition, in some configurations, when one or more of the frame buffers 260 are implemented with respect to the first data stream of image data, the electronic processor 202 may analyze or interrogate one or more of the frame buffers 260 (or a frame thereof) as part of identifying the object(s). In some configurations, the electronic processor 202 may perform one or more image analytic techniques or functions, such as object recognition functionality, object tracking functionality, facial recognition functionality, eye tracking functionality, voice recognition functionality, gesture recognition, etc., as part of identifying the object.

At block 815 of FIG. 8, the electronic processor 202 of FIG. 2 may determine a set of characteristics of the object. In some configurations, the electronic processor 202 may determine a characteristic of the object using one or more CV techniques (e.g., one or more of the CV models stored in the memory 205). For instance, in some configurations, the electronic processor 202 analyzes the first data stream of image data using a CV model (e.g., stored in the memory 205). Alternatively, or in addition, in some configurations, the electronic processor 202 may determine a characteristic of the object using one or more image analytic techniques or functions, such as object recognition functionality, object tracking functionality, facial recognition functionality, eye tracking functionality, voice recognition functionality, gesture recognition, etc., as part of determining a characteristic of the object.

In some configurations, a characteristic of the object is a position of the object (e.g., a position of the object in physical space). In some configurations, the position of the object may be a multi-dimensional position of the first object in physical space. In some configurations, the position of the object represents a current position of the object. The position of the object may be relative to a second data stream of displayed digital content. For instance, in some configurations, the position of the object may be associated with a virtual interactive region (e.g., the virtual interactive regions 405V of FIG. 4). The set of characteristics may include multiple positions of the object (e.g., a first position of the object, a second position of the object, and the like). Accordingly, in some configurations, the electronic processor 202 of FIG. 2 may detect and identify a change in position of the object based one two or more positions of the object. In some configurations, a change in position of the object may represent a gesture. Accordingly, in some configurations, the electronic processor 202 may detect and identify a gesture based on the set of characteristics.

Alternatively, or in addition, in some configurations, a characteristic of the object is an arrangement of the object. An arrangement may refer to a disposition or orientation of the object. As one non-limiting example, when the object is a user's hand, the object may be in a first arrangement when the user's hand is open (e.g., an open-hand arrangement), a second arrangement when the user's hand is closed (e.g., a closed-hand arrangement), a third arrangement when the user's hand is holding up two fingers (e.g., a two-finger raised arrangement), etc. Accordingly, in some configurations, the set of characteristics may include multiple arrangements of the object (e.g., a first arrangement of the object, a second arrangement of the object, and the like).

Accordingly, in some configurations, the electronic processor 202 may detect and identify a change in arrangement of the object based one two or more arrangements of the object. In some configurations, a change in arrangement may represent a gesture performed by the object. As one non-limiting example, when the object is a user's hand, a first arrangement of the user's hand may be an open-hand arrangement and a second arrangement of the user's hand may be a closed hand arrangement. Following this non-limiting example, when the user's hand continuously switches between the first arrangement and the second arrangement, the change in arrangement may represent a good-bye wave (as a gesture performed by the object).

In some configurations, a characteristic of the object may include an identification of the object. As one non-limiting example, when the object is a user, the characteristic of the object may be an identification of the user (e.g., John Smith). In some configurations, the object may be an inanimate object. In such configurations, the inanimate object may be associated with a unique identifier. A “unique identifier” is a mechanism for distinguishing an object (or user) from another object (or user). For example, a unique identifier may be a “reference patch” or “marker” which is unique to the object or person. As one non-limiting example, an object may be a smart phone. The smart phone may function as a user's unique identifier. For instance, imaging devices (e.g., cameras) may be used to see picture of person on screen or to directly see the person and then create a “reference patch” or a “marker” that uniquely identifies the person. Rather than a live/dynamic validation, the phone may have a unique reference patch or marker, such as a QR code or other image or code that communicates the identity of the phone or the person using the phone.

Alternatively, or in addition, in some configurations, a characteristic of the object may include a property or parameter of the object. As another non-limiting example, when the object is a user's left-hand, the characteristic of the object may be an indication that the object is a user's left-hand. As another non-limiting example, when the object is a door, the characteristic of the object may include an indication that the object is a door, a status of the door (e.g., an open status, a closed status, a partially closed status, an unlocked status, a locked status, etc.), etc. As yet another non-limiting example, when the object is a clock, the characteristic of the object may include a time displayed by the clock.

The electronic processor 202 may determine a command (at block 820 of FIG. 8). In some configurations, the electronic processor 202 of FIG. 2 may detect the interaction of the object with content being displayed, or based on one or more characteristics of the object (such as determining a command indicated by a gesture and/or location,). Alternatively, or in addition, in some configurations, the electronic processor 202 may detect the interaction based on the set of characteristics relative to the second data stream of displayed digital content (e.g., one or more interactive regions of the displayed digital content).

In some configurations, the electronic processor 202 may detect an interaction of the object with the displayed digital content based on a position of the object (as included in the set of characteristics) relative to a virtual interactive region, which corresponds to an interactive region of the displayed digital content. The electronic processor 202 may detect an interaction with a virtual interactive region when the position of the object is such that at least a portion of the object overlaps with (or collides with) a boundary or edge of the virtual interactive region. As one non-limiting example, when the object is a user's hand, the electronic processor 202 may detect an interaction with displayed digital content when the user's hand is positioned within one of the virtual interactive regions.

The electronic processor 202 may execute an instruction associated with the command (at block 825 of FIG. 8). As noted herein, each gesture and/or interactive region (or virtual interactive region) may be associated with an instruction that is triggered in response to detection of a command (e.g., an interaction with a virtual interaction region associated with a portion of the displayed digital content). Accordingly, in some configurations, in response to detecting a contactless interaction with an interactive region (e.g., an interaction with a virtual interaction region), the electronic processor 202 of FIG. 2 may execute interactive functionality associated with that interactive region.

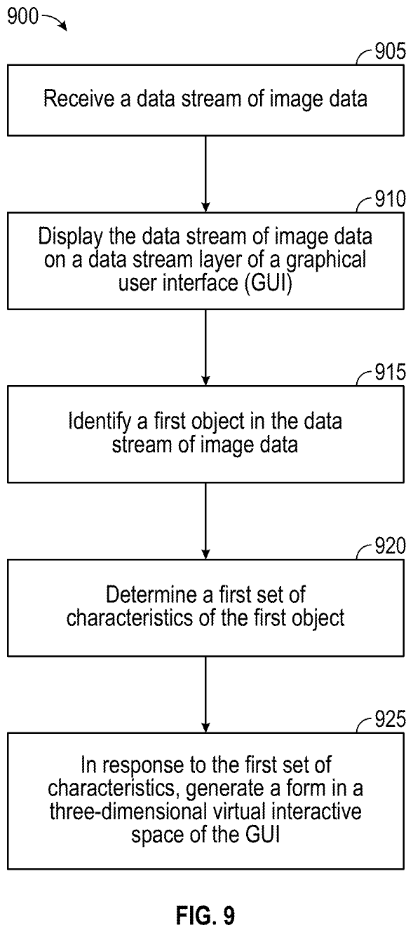

FIG. 9 is a flowchart illustrating a method 900 for implementing contactless interactions according to some configurations described herein. The method 900 is described as being performed by the target device 115 of FIG. 1 and, in particular, the photonic peripheral application 245 as executed by the electronic processor 202. However, as noted above, the functionality described with respect to the method 900 may be performed by other devices, such as the user device 110, or distributed among multiple devices, such as multiple servers included in a cloud service (e.g., a web-based service executing software or applications associated with a platform, service, or application).

At block 905 of FIG. 9, the electronic processor 202 of FIG. 2 may receive a data stream of image data. In some examples, the data stream of image data can be received from the imaging device 219 for the user 140 and/or the communication interface 210 for other user(s). In further examples, the data stream of image data may be a continuous time-series data.

At block 910 of FIG. 9, the electronic processor 202 of FIG. 2 may display the data stream of image data on a data stream layer of a graphical user interface (GUI). For example, the device displays the GUI, which includes multiple layers (e.g., the background layer 502, a data stream layer 504, a digital content layer 506, and/or a three-dimensional interactive space 508). In some examples, a layer refers to digital data displayed in a window of the display device 217 of the device 110, 115. In the multiple layers of the GUI, a layer may be a superimposed layer overlayed or superimposed on another layer. The device 110, 115 may blur, hide, or make opaque the data or content displayed on another layer 502 as an underlying layer for the superimposed layer. Thus, the data or content displayed on the superimposed layer can be translucent or opaque to display the data or content on the superimposed layer clearer than other displayed data on the underlying layer.

At block 915 of FIG. 9, the electronic processor 202 of FIG. 2 may identify a first object in the data stream of image data. In some examples, the first object includes a body part of a human. For example, the body part of a human can include a hand, an arm, a leg, a face, the whole body, or any other suitable body part. It should be appreciated that the first object is not limited to a human. For example, the first object may include a non-human object (e.g., a stick, a ball, a box, a vehicle, etc.).

At block 920 of FIG. 9, the electronic processor 202 of FIG. 2 may determine a first set of characteristics of the first object. In some examples, the first set of characteristics may include a first gesture and/or a first location of the first object. For example, the first gesture may include a pinching finger gesture. However, it should be appreciated that the first gesture may be any other suitable gesture. In further examples, the electronic processor 202 may determine a second set of characteristics of the first object. The second set of characteristics of the first object may include a second position of the first object, which is different from the first position of the first object. In some examples, the data stream as time-series data may include the first and second positions of the first object at different times.

In further examples, the electronic processor 202 of FIG. 2 may display a virtual object corresponding to the first object based on the first set of characteristics of the first object in the three-dimensional virtual interactive space. For example, the electronic processor 202 may identify the hand on the data stream layer and display a virtual hand (e.g., in a two-dimensional form) and the pinching finger gesture of the virtual hand in the three-dimensional virtual interactive space.

At block 925 of FIG. 9, the electronic processor 202 of FIG. 2 may in response to the first set of characteristics, generate a form in a three-dimensional virtual interactive space of the GUI. In some examples, the form may include a sphere, a cylinder, a cone, a polygonal pyramid, a polygonal prism, a cube, a cuboid, user's three-dimensional skeleton or user's body (which can copy the user's movement) or any other suitable two-dimensional or three-dimensional object. In some examples, the electronic processor 202 may recognize the first set of characteristics as a command to perform a particular task (e.g., start generating a form (e.g., a sphere, a cylinder, a cone, a polygonal pyramid, a polygonal prism, a cube, a cuboid, user's three-dimensional skeleton or user's body or any other suitable two-dimensional or three-dimensional object)), stopping generating the form, removing the form, moving the form, revising the form, etc.). For example, the electronic processor 202 may recognize the pinching finger gesture as a form generation initiation command. In some examples, the electronic processor may generate the form in the three-dimensional virtual interactive space of the GUI using the virtual object displayed in the three-dimensional virtual interactive space in response to the first set of characteristics. In further examples, to generate the form in the three-dimensional virtual interactive space, the electronic processor may track movement of the first object from the first position to the second position of the first object; and generate the form in the three-dimensional virtual interactive space based on the movement from the first position to the second position of the first object.

In further examples, the generated form can have different depths in the three-dimensional virtual interactive space. In some examples, a depth of a form may refer to a virtual distance in Z axis from a reference X-Y plane (e.g., the background layer, the data stream layer, digital content layer, or any other suitable X-Y plane in the three-dimensional virtual interactive space) at a right angle. For example, a first depth of a first location of the form corresponding to the first position is different from a second depth of a second location of the form corresponding the second position. In further examples, the electronic processor 202 may determine the first depth and the second depth of the form based on a first time to generate the form at the first position and a second time to generate the form at the second position. In some scenarios, when the form is a drawing line, the starting point of the form may have a deeper depth than the end point of the form. In other scenarios, the end point of the form may have a deeper depth than the starting point of the form.

In further examples, the electronic processor 202 may display the depths of the form in response to a location of a second object (e.g., the head, eyes, non-human object, or any other suitable object). For example, the electronic processor 202 may identify a first location of the second object at a first time in the data stream. In some examples, the first location of the second object being different from a second location of the second object at a second time in the data stream. The electronic processor 202 may further display the form with different depths on the display. In some examples, the form displayed based on the second location of the second object may have a different shape displayed on the GUI from the form displayed on the GUI based on the first location of the second object. The different shape of the form may be caused by the depths of the form. For examples, the three-dimensional form projected on the X-Y plane (0® angle) may have a different shape from the three-dimensional form projected on a plane with 30® angle because the three-dimensional form projected on a plane with 30® angle shows depths of the form while the three-dimensional form projected on a plane with 0® angle does not show any depth of the form.

In further examples, the electronic processor 202 may display a digital content on a digital content layer of the GUI. In some examples, the digital content layer may be a second superimposed layer over the data stream layer and may be an underlying layer to the three-dimensional virtual interactive space. In further examples, the electronic processor 202 may control the digital content displayed on the digital content layer based on the form generated in the three-dimensional virtual interactive space.

In even further examples, the electronic processor 202 may determine a first location of the first object at a first time and a second location of the first object. Then, the electronic processor 202 may move the form in the three-dimensional virtual interactive space based on the movement from the first position to the second position of the first object.

While this specification contains many specific implementation details, these should not be construed as limitations on the scope of what may be claimed, but rather as descriptions of features that may be specific to particular embodiments.

A variety of concepts are discussed herein. Related thereto and incorporated herein by reference in their entirety are U.S. application Ser. No. 17/408,065, filed on Aug. 20, 2021 and issued as U.S. Pat. No. 11,277,658 and U.S. patent application Ser. No. 17/675,946, filed Feb. 18, 2022; Ser. No. 17/675,718, filed Feb. 18, 2022; Ser. No. 17/675,819, filed Feb. 18, 2022; Ser. No. 17/675,748, filed Feb. 18, 2022; Ser. No. 17/675,950, filed Feb. 18, 2022; Ser. No. 17/675,975, filed Feb. 18, 2022; Ser. No. 17/675,919, filed Feb. 18, 2022; Ser. No. 17/675,683, filed Feb. 18, 2022; Ser. No. 17/675,924, filed Feb. 18, 2022; Ser. No. 17/708,656, filed Mar. 30, 2022; Ser. No. 17/687,585, filed Mar. 4, 2022; and Ser. No. 18/073,439, filed Dec. 1, 2022; and U.S. Provisional Application No. 63/400,318, filed Aug. 23, 2022.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Obviously, numerous modifications and variations are possible in light of the above teachings. It is therefore to be understood that within the scope of the appended claims, embodiments of the present disclosure may be practiced otherwise than as specifically described herein.

### Further Examples Having a Variety of Features

The disclosure may be further understood by way of the following examples:

Example 1: A method, apparatus, and non-transitory computer-readable medium for implementing contactless interactions comprises: receiving a data stream of image data; displaying the data stream of image data on a data stream layer of a graphical user interface (GUI); identifying a first object in the data stream of image data; determining a first set of characteristics of the first object; and in response to the first set of characteristics, generating a form in a three-dimensional virtual interactive space of the GUI, the three-dimensional virtual interactive space being a first superimposed layer over the data stream layer of the display.

Example 2: The method, apparatus, and non-transitory computer-readable medium according to Example 1, wherein the first object includes a body part of a user displayed on the data stream layer.

Example 3: The method, apparatus, and non-transitory computer-readable medium according to Example 1 or 2, wherein the first set of characteristics includes a first gesture.

Example 4: The method, apparatus, and non-transitory computer-readable medium according to any of Examples 1-3, wherein the first set of characteristics includes a first position of the first object.

Example 5: The method, apparatus, and non-transitory computer-readable medium according to any of Examples 1-4, further comprising: displaying a virtual object corresponding to the first object based on the first set of characteristics of the first object in the three-dimensional virtual interactive space, wherein to generate the form in the three-dimensional virtual interactive space, the electronic processor is configured to: in response to the first set of characteristics, generate the form in the three-dimensional virtual interactive space of the GUI using the virtual object displayed in the three-dimensional virtual interactive space.

Example 6: The method, apparatus, and non-transitory computer-readable medium according to any of Examples 1-5, further comprising: determining a second set of characteristics of the first object, the second set of characteristics including a second position of the first object, wherein generating the form in the three-dimensional virtual interactive space comprises: tracking movement of the first object from the first position to the second position of the first object; and generating the form in the three-dimensional virtual interactive space based on the movement from the first position to the second position of the first object.

Example 7: The method, apparatus, and non-transitory computer-readable medium according to any of Examples 1-6, wherein a first depth of a first location of the form corresponding to the first position is different from a second depth of a second location of the form corresponding the second position.

Example 8: The method, apparatus, and non-transitory computer-readable medium according to any of Examples 1-7, further comprising: determining the first depth and the second depth of the form based on a first time to generate the form at the first position and a second time to generate the form at the second position.

Example 9: The method, apparatus, and non-transitory computer-readable medium according to any of Examples 1-8, further comprising: determining a second set of characteristics of the first object, the second set of characteristics including a second position of the first object; and moving the form in the three-dimensional virtual interactive space based on movement from the first position to the second position of the first object.

Example 10: The method, apparatus, and non-transitory computer-readable medium according to any of Examples 1-9, further comprising: identifying a first location of a second object at a first time in the data stream, the first location of the second object being different from a second location of the second object at a second time in the data stream; and displaying the form with different depths on the display, the form displayed based on the second location of the second object having a different shape displayed on the GUI from the form displayed on the GUI based on the first location of the second object.

Example 11: The method, apparatus, and non-transitory computer-readable medium according to any of Examples 1-10, further comprising: displaying a digital content on a digital content layer of the GUI, the digital content layer being a second superimposed layer over the data stream layer and being an underlying layer to the three-dimensional virtual interactive space.

Example 12: The method, apparatus, and non-transitory computer-readable medium according to any of Examples 1-11, further comprising: controlling the digital content displayed on the digital content layer based on the form generated in the three-dimensional virtual interactive space.

In some configurations, aspects of the technology, including computerized implementations of methods according to the technology, may be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, configurations of the technology can be implemented as a set of instructions, tangibly embodied on a non-transitory computer-readable media, such that a processor device can implement the instructions based upon reading the instructions from the computer-readable media. Some configurations of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, may be represented schematically in the FIGS. 1-9 or otherwise discussed herein. Unless otherwise specified or limited, representation in the FIGS. 1-9 of particular operations in particular spatial order may not necessarily require those operations to be executed in a particular sequence corresponding to the particular spatial order. Correspondingly, certain operations represented in the FIGS. 1-9, or otherwise disclosed herein, can be executed in different orders than are expressly illustrated or described, as appropriate for particular configurations of the technology. Further, in some configurations, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as “either,” “one of” “only one of” or “exactly one of.”

Although the present technology has been described by referring to preferred configurations, workers skilled in the art will recognize that changes may be made in form and detail without departing from the scope of the discussion.

What is claimed is:

1. A system for implementing contactless interactions, the system comprising:
a memory; and
an electronic processor coupled to the memory and configured to:
receive a data stream of image data;
display the data stream of image data on a data stream layer of a graphical user interface (GUI);
identify a first object in the data stream of image data;
determine a first set of characteristics of the first object; and
in response to the first set of characteristics, generate a form in a three-dimensional virtual interactive space of the GUI, the three-dimensional virtual interactive space being a first superimposed layer over the data stream layer of the display.

2. The system of claim 1, wherein the first object includes a body part of a user displayed on the data stream layer.

3. The system of claim 1, wherein the first set of characteristics includes a first gesture.

4. The system of claim 1, wherein the first set of characteristics includes a first position of the first object.

5. The system of claim 4, wherein the electronic processor is further configured to:
display a virtual object corresponding to the first object based on the first set of characteristics of the first object in the three-dimensional virtual interactive space,
wherein to generate the form in the three-dimensional virtual interactive space, the electronic processor is configured to: in response to the first set of characteristics, generate the form in the three-dimensional virtual interactive space of the GUI using the virtual object displayed in the three-dimensional virtual interactive space.

6. The system of claim 4, wherein the electronic processor is further configured to:
determine a second set of characteristics of the first object, the second set of characteristics including a second position of the first object,
wherein to generate the form in the three-dimensional virtual interactive space, the electronic processor is configured to:
track movement of the first object from the first position to the second position of the first object; and
generate the form in the three-dimensional virtual interactive space based on the movement from the first position to the second position of the first object.

7. The system of claim 6, wherein a first depth of a first location of the form corresponding to the first position is different from a second depth of a second location of the form corresponding the second position.

8. The system of claim 7, wherein the electronic processor is further configured to:
determine the first depth and the second depth of the form based on a first time to generate the form at the first position and a second time to generate the form at the second position.

9. The system of claim 4, wherein the electronic processor is further configured to:
determine a second set of characteristics of the first object, the second set of characteristics including a second position of the first object; and
move the form in the three-dimensional virtual interactive space based on movement from the first position to the second position of the first object.

10. The system of claim 1, wherein the electronic processor is further configured to:
identify a first location of a second object at a first time in the data stream, the first location of the second object being different from a second location of the second object at a second time in the data stream; and
display the form with different depths on the display, the form displayed based on the second location of the second object having a different shape displayed on the GUI from the form displayed on the GUI based on the first location of the second object.

11. The system of claim 1, wherein the electronic processor is further configured to:
display a digital content on a digital content layer of the GUI, the digital content layer being a second superimposed layer over the data stream layer and being an underlying layer to the three-dimensional virtual interactive space.

12. The system of claim 11, wherein the electronic processor is further configured to:
control the digital content displayed on the digital content layer based on the form generated in the three-dimensional virtual interactive space.

13. A method for implementing contactless interactions, the method comprising:
receiving a data stream of image data;
displaying the data stream of image data on a data stream layer of a graphical user interface (GUI);
identifying a first object in the data stream of image data;
determining a first set of characteristics of the first object; and
in response to the first set of characteristics, generating a form in a three-dimensional virtual interactive space of the GUI, the three-dimensional virtual interactive space being a first superimposed layer over the data stream layer of the display.

14. The method of claim 13, wherein the first set of characteristics includes a first position of the first object.

15. The method of claim 14, further comprising:
displaying a virtual object corresponding to the first object based on the first set of characteristics of the first object in the three-dimensional virtual interactive space;
wherein generating the form in the three-dimensional virtual interactive space comprises: in response to the first set of characteristics, generating the form in the three-dimensional virtual interactive space of the GUI using the virtual object displayed in the three-dimensional virtual interactive space.

16. The method of claim 14, further comprising:
determining a second set of characteristics of the first object, the second set of characteristics including a second position of the first object,
wherein generating the form in the three-dimensional virtual interactive space comprises:
tracking movement of the first object from the first position to the second position of the first object; and
generating the form in the three-dimensional virtual interactive space based on the movement from the first position to the second position of the first object.

17. The method of claim 16, wherein a first depth of a first location of the form corresponding to the first position is different from a second depth of a second location of the form corresponding the second position.

18. The method of claim 14, further comprising:
determining a second set of characteristics of the first object, the second set of characteristics including a second position of the first object; and
moving the form in the three-dimensional virtual interactive space based on movement from the first position to the second position of the first object.

19. The method of claim 13, further comprising:
identifying a first location of a second object at a first time in the data stream, the first location of the second object being different from a second location of the second object at a second time in the data stream; and
displaying the form with different depths on the display, the form displayed based on the second location of the second object having a different shape displayed on the GUI from the form displayed on the GUI based on the first location of the second object.

20. The method of claim 13, further comprising:
displaying a digital content on a digital content layer of the GUI, the digital content layer being a second superimposed layer over the data stream layer and being an underlying layer to the three-dimensional virtual interactive space.
